(19) United States
(12) Patent Application Publication
(10) Pub. No.: US 2021/0058748 A1
(43) Pub. Date: Feb. 25, 2021

(54) SYSTEMS AND METHODS FOR GROUP BASED SERVICES PROVISIONING

(71) Applicant: Apple Inc., Cupertino, CA (US)

(72) Inventor: Ching-Yu Liao, Portland, OR (US)

(73) Assignee: Apple Inc., Cupertino, CA (US)

(21) Appl. No.: 16/479,557

(22) PCT Filed: Mar. 23, 2018
(86) PCT No.: PCT/US2018/024157

§ 371 Date: Jul. 19, 2019

Related U.S. Application Data
(60) Provisional application No. 62/476,611, filed on Mar. 24, 2017.
(60) Provisional application No. 62/487,908, filed on Apr. 20, 2017.

(51) Int. Cl. H04W 4/08; H04W 8/08; H04W 48/16; H04W 76/11; H04L 29/12

(52) U.S. Cl. CPC H04W 4/08; H04W 8/08; H04W 84/12; H04W 76/11; H04L 61/2061; H04W 48/16

(57) ABSTRACT

Systems and methods are provided for pervasive connectivity for group based service (GBS) provisioning. In addition, or in other embodiments, groupcast services provisioning in 5G systems is described. An example apparatus for GBS provisioning for pervasive connectivity in a mobile network includes a memory interface and a processor. The memory interface to send or receive, to or from a memory device, an application identifier (ID) value, and a temporary group based service ID (TGSID) value. The processor to process a service request from an access and mobility management function (AMF). The service request includes the application ID value and the TGSID value associated with a groupcast service. In response to the service request, the processor enables groupcast service at one or more associated access stratum network entities for forwarding groupcast internet protocol (IP) packets.

### RELATED APPLICATIONS

This application claims the benefit of U.S. Provisional Patent Application No. 62/476,611, filed Mar. 24, 2017, and of U.S. Provisional Patent Application No. 62/487,908, filed Apr. 20, 2017, each of which is hereby incorporated by reference herein in its entirety.

### TECHNICAL FIELD

This application relates generally to wireless communication systems, and more specifically to group communication.

### BACKGROUND

Wireless mobile communication technology uses various standards and protocols to transmit data between a base station and a wireless mobile device. Wireless communication system standards and protocols can include the 3rd Generation Partnership Project (3GPP) long term evolution (LTE); the Institute of Electrical and Electronics Engineers (IEEE) 802.16 standard, which is commonly known to industry groups as worldwide interoperability for microwave access (WiMAX); and the IEEE 802.11 standard for wireless local area networks (WLAN), which is commonly known to industry groups as Wi-Fi; and the MulteFire standard developed by MulteFire Alliance. In 3GPP radio access networks (RANs) in LTE systems, the base station can include a RAN Node such as a Evolved Universal Terrestrial Radio Access Network (E-UTRAN) Node B (also commonly denoted as evolved Node B, enhanced Node B, eNodeB, or eNB) and/or Radio Network Controller (RNC) in an E-UTRAN, which communicate with a wireless communication device, known as user equipment (UE) and in MulteFire systems can include a MF-AP. In fifth generation (5G) wireless RANs, RAN Nodes can include a 5G Node, new radio (NR) node or g Node B (gNB). Additional details of 5G systems are discussed below.

Communication may be classified, for example, as unicast, broadcast, and groupcast/multicast. Unicast is used to describe communication where information is sent from one point (i.e., a single source) to another point being a specified destination. In this case there is just one sender, and one receiver. Communication where a single device is transmitting a message to all other devices in a given address range, is described by broadcast. Groupcast and/or multicast is used to describe communication where information is sent from one or more points to a set of other points. In this case there may be one or more senders, and information is distributed to a set of receivers. The set may however comprise no receivers or any other number of receivers. The format of groupcast/broadcast/multicast packets may be identical to that of unicast packets and may be distinguished only by the use of a special class of destination address. Unlike broadcast transmission, multicast clients may receive a stream of packets only if they have previously elected to do so, for example by joining the specific groupcast/multicast group address.

The end to end transport path using the broadcast/groupcast/multicast transmission contains the mechanism for packets delivery via core network and the radio network. The packets delivery using unicast transmission at the radio network to the UE can be multicast/groupcast transmission from the core network by duplicating packets at radio network for delivery to multiple UEs subscribed to the groupcast service. The packets delivery using multicast/broadcast at the radio network to the UE can be referring to the packet delivery using broadcast/multicast channel over the air interface.

### BRIEF DESCRIPTION OF THE DRAWINGS

FIG. 1 is a block diagram of a system architecture in an evolved packet system for group based services according to certain embodiments described herein.

FIG. 2 is a block diagram of a 5G network architecture with service-based interfaces according to certain embodiments described herein.

FIG. 3 is a block diagram of an example 5G system architecture in support of group based services in reference point representation according to certain embodiments.

FIG. 4 is a flow diagram of a high level group based service procedure according to certain embodiments.

FIG. 5 is a block diagram of an example system architecture according to one embodiment.

FIG. 6 is a block diagram of an example system architecture configured according to certain embodiments.

FIG. 7 is a high-level flow diagram of an application server initiated group service procedure according to certain embodiments

FIG. 8 illustrates an architecture of a system of a network in accordance with some embodiments.

FIG. 9 illustrates example components of a device in accordance with some embodiments.

FIG. 10 illustrates example interfaces of baseband circuitry in accordance with some embodiments.

FIG. 11 is an illustration of a control plane protocol stack in accordance with some embodiments.

FIG. 12 is an illustration of a user plane protocol stack in accordance with some embodiments.

FIG. 13 illustrates components of a core network in accordance with some embodiments.

FIG. 14 is a block diagram illustrating components, according to some example embodiments, able to read instructions from a machine-readable or computer-readable medium (e.g., a non-transitory machine-readable storage medium) and perform any one or more of the methodologies discussed herein.

FIGS. 15A and 15B are flow diagrams of methods for pervasive connectivity for group based services provisioning according to certain embodiments.

FIGS. 16A, 16B and 16C are flow diagrams of methods for groupcast services provisioning according to certain embodiments.

### DETAILED DESCRIPTION OF PREFERRED EMBODIMENTS

The following detailed description refers to the accompanying drawings. The same reference numbers may be used in different drawings to identify the same or similar elements. In the following description, for purposes of explanation and not limitation, specific details are set forth such as particular structures, architectures, interfaces, techniques, etc. in order to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail. For the purposes of the present document, the phrase “A or B” means (A), (B), or (A and B).

In 3GPP Evolved Packet System (EPS), LTE based multicast and broadcast mobile services (MBMS) are used broadly for provisioning group based services (GBS), e.g. vehicle-to-everything (V2X) communications over LTE-Uu interface, group messaging delivery, and mission critical related services, etc. It is expected that MBMS/MBMS-similar transmission/architecture will continue to play an role in 5G/5G+ systems.

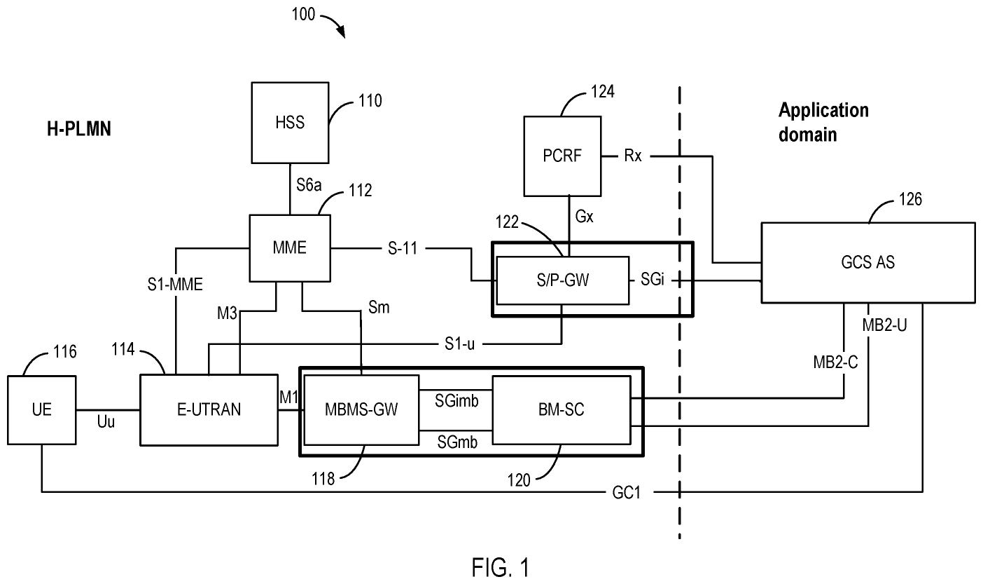

FIG. 1 is a block diagram of a system architecture 100 in EPS for group based services. The system architecture 100 includes a home subscriber server (HSS) 110 connected through an S6a interface to a mobility management entity (MME) 112, which is connected through an S1-MME interface to an E-UTRAN 114. A UE 116 is connected through a Uu interface to the E-UTRAN 114. The E-UTRAN 114 is further connected to an MBMS gateway (MBMS-GW) 118 through an M1 interface, to the MME 112 through an M3 interface, and to a serving/packet gateway (S/P-GW) 122 through an S1-u interface. The S/P-GW 122 is further connected to the MME through an S-11 interface, a policy and charging rules function (PCRF) 124 through a Gx interface, and a group communication system application server (GCS AS) 126 through an SGi interface. The GCS AS 126 is connected to the PCRF 124 through an Rx interface, to a broadcast multicast service center (BM-SC) 120 through MB2-C and MB2-U interfaces, and to the UE 116 through a GC1 interface. The MBMS-GW 118 if further connected to the MB-SC 120 through SGimb and SGmb interfaces, and to the MME 112 through an Sm interface.

The UE 116 can switch between unicast and multicast/broadcast services. The S/P-GW 122 provides the unicast path. The MBMS-GW 118 and the BM-SC 120 provide the multicast/broadcast path. For LTE, MBMS (see, e.g., 3GPP Technical Report (TR) 23.799 V.0.8.1 (2016-09), “Study on Architecture for Next Generation System”) may provide criteria in support of group handling and group communication for one-to-many (1:many) communication and one-to-all (1:all) communication involving 5G capabilities specified by RAN. Thus, LTE-MBMS (e.g., see 3GPP Technical Specification (TS) 36.300 V14.0.0 (2016-09), “E-UTRA and E-UTRAN Overall Description; Stage 2”) may be the foundation of groupcast services provisioning for 5G. See also, 3GPP TS 23.501 V0.3.0 (2017-02): “System Architecture for the 5G System; Stage 2.”

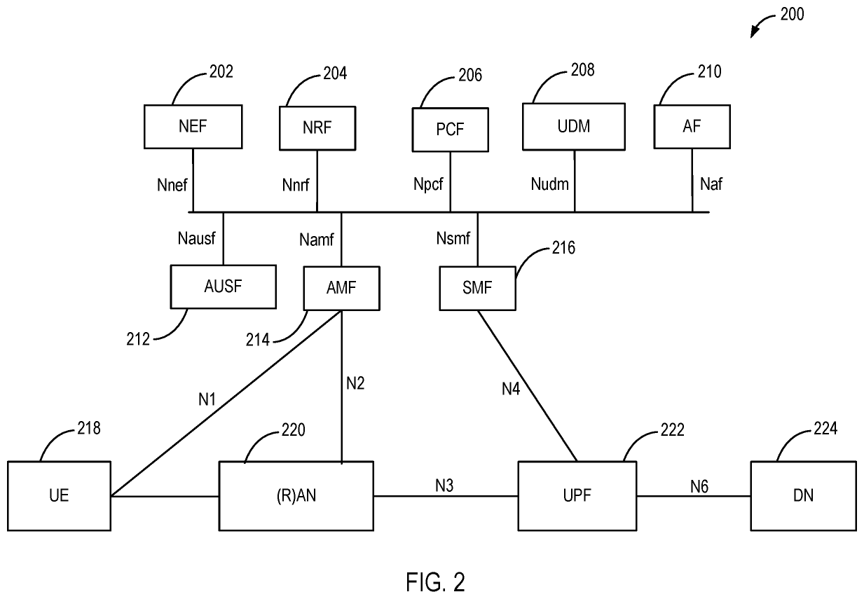

In 3GPP TS 23.501, for example, a 5G system architecture may be as shown in FIG. 2, which depicts the non-roaming reference architecture 200 with service-based interfaces (e.g., Nnef, Nnrf, Npcf, Nudm, Naf, Nausf, Namf, Nsmf, N1, N2, N3, N4, N6) within the control plane. The 5G network architecture 200 includes, for example, a network exposure function (NEF) 202, a network repository function (NRF) 204, a policy control function (PCF) 206, a unified data management (UDM) 208, an application function (AF) 210, an authentication server function (AUSF) 212, an access and mobility management function (AMF) 214, and a session management function (SMF) 216. Also shown are a UE 218, a (radio) access network ((R)AN) 220, a user plane function (UPF) 222, and a data network (DN) 224. In certain embodiments, the AMF 214 is the core network controller, the (R)AN 220 provides 3GPP access, and non-3GPP access may be provided through, e.g., a WLAN access point (AP).

Certain embodiments herein are directed to pervasive connectivity for group based services provisioning. In addition, or in other embodiments, groupcast services provisioning in 5G systems is described.

### A. Pervasive Connectivity for Group Based Services in 5G/5G+ Systems

In order to provide pervasive connectivity in 5G/5G+ systems, the next generation core (NGC) is designed to be access agnostic for both 3GPP access (e.g., gNB, next generation eNB) and non-3GPP access (e.g., WLAN, wireline access, etc.). With the existing LTE based MBMS transmission/architecture, the non-3GPP access is becoming a missing piece. Therefore, embodiments herein may include solutions for provisioning versatile group based services via non-3GPP access in 5G/5G+ systems.

The framework benefits an internet of things (IoT) device, e.g., smart home thermometers, smart meters, etc., with only non-3GPP access to get group based services from a 5G/5G+ system. Moreover, for a device with both 3GPP and non-3GPP access capabilities but temporarily moving into a coverage hole of 3GPP access, it is beneficial that the service continuity is assured for the device continuing to receive group based service via non-3GPP access, e.g., video broadcasting services. For some cases that both accesses are available to a device, the device may switch between 3GPP and non-3GPP accesses based on pre-provisioned roaming policies.

Various embodiments may include solutions for resolving one or more of the following issues: How does the 3GPP network activate the groupcast transmission over WLAN and provide GBS to UEs registered via WLAN-AP? How does the 3GPP network provide the system information to the UE registered via WLAN-AP? What is the system information? How to define a service area of the WLAN and how it is related to GBS service area? How does the network trigger WLAN operating in groupcast/broadcast/unicast transmission for GBS? How is the transmission synchronized for the UEs using GBS via WLAN? How does the network provide service continuity of the UE registered via WLAN-AP? How does the UE start to receive the GBS packets sent by the associated WLAN AP?

Two alternatives may be included in various embodiments to activate GBS for groupcast transmission over WLAN-AP, in which one is via an application server and another is via an N1 signaling message (between the UE and the AMF in the core network control plane function (CN-CPF)).

In certain embodiments, the system information in support of a particular GBS may be broadcast via WLAN-AP for a GBS identified by an application-ID and/or a temporary group based service ID (TGSID) depending on the supported transmission modes, e.g., unicast, broadcast, groupcast, in the WLAN-AP. The system information related to the non-3GPP access may additionally be broadcast via one or more 3GPP RAN nodes, which could be used when making roaming decision by the UEs capable of both accesses.

In certain embodiments, according to authorized service areas of the GBS, the non-3GPP interworking function (N3IWF) determines one or more logical virtual cells in which each virtual cell is identified by a virtual cell ID.

In certain embodiments, to provide service continuity for UEs moving around WLAN-APs for the GBS, the N3IWF determines a logical virtual cell which is identified by a virtual cell ID and configures one or more WLAN-APs with a service set ID (SSID)/extended SSID (ESSID), accordingly. The WLAN-APs associated to the same virtual cell ID shares the same security parameters.

In certain embodiments, the group based service can be activated for UE using WLAN access in unicast, broadcast, or groupcast transmission modes.

In certain embodiments, the network determines a network slice for accommodating one or more GBS, which includes a common core network slice for groupcast transmission as well as a RAN slice with one or more RAN nodes and WLAN-APs. The RAN slice may support transmission of the GBS packets in unicast/broadcast/groupcast modes.

Various embodiments may include one or more of the following advantages: provide pervasive connectivity for group based service provisioning, which used to support 3GPP access only (e.g. LTE-based MBMS service in EPC); support service continuity by allowing the network to manage authorized service areas for non-3GPP access technologies (e.g., WLAN) via proper WLAN-APs configuration and IP addresses allocation for SSID/ESSID and virtual cell; provide flexible radio resource management functionality by allowing the network to activate different transmission mode (e.g., unicast, broadcast, groupcast) for group based service provisioning over WLAN, e.g., depending on the WLAN capability, available radio resource; provide access agnostic network slicing solution, which includes a common core network slice for groupcast transmission as well as a RAN slice with one or more RAN nodes and WLAN-APs, and uses network resources efficiently by sharing the same user plane context among different radio access networks. Thus, embodiments disclosed herein provide efficient and flexible methods to resolve the above issues.

Some embodiments may make one or more of the following assumptions: the GBS data can be transported by the 3GPP network in terms of unicast, broadcast, groupcast mode; the GBS has been provisioned by the network for 3GPP based transmission (e.g. LTE based transmission, New Radio based transmission) with an authorized service area and application identifier (ID); the UE is WLAN-access capable; the UE has successfully attached to the network via an WLAN-AP, and has established a packet data unit (PDU) session which is an association between the UE and a data network that provides a PDU connectivity service; the UE uses the PDU connectivity service to obtain the GBS with service metadata information which may be used to control the service at the UE from an application server or a group based service function (GBSF) via http or short message service (SMS) over WLAN service. Then the UE is configured with the user service description (USD) for GBS reception; and the UE registers to the group based application server. In the core network, a GBSF, which can reside with other control plane functions, is introduced for handling GBS service policies, conducting group management for UEs joining/leaving GBS groups, and allocate a TGSID to the application server.

### A(1) Example System Architecture for GBS

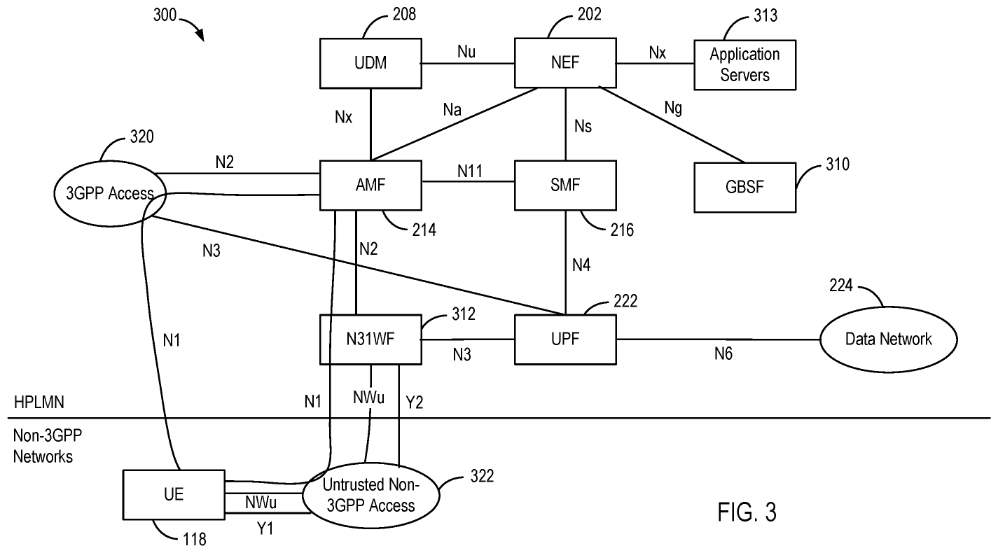

FIG. 3 is a block diagram of an example 5G system architecture 300 in support of group based services in reference point representation according to certain embodiments. The system architecture 300 includes a home public land mobile network (HPLMN) comprising a UDM 208, NEF 202, application servers 313, an AMF 214, an SMF 216, a GBSF 310 an N3IWF 312, a UPF 222, a 3GPP access 320 (e.g., RAN node), and a data network 224. The system architecture 300 also provides for non-3GPP networks wherein a UE 218 may access the HPLMN through untrusted non-3GPP access 322. FIG. 3 also shows the interfaces or reference points between the various entities of the system architecture 300 (e.g., N1, N2, N3, N4, N6, N11, Na, Ng, Ns, Nu, NWu, Nx, Y1, and Y2). The untrusted non-3GPP access 322 in this invention is one of the embodiments but not limited to. Other embodiments for non-3GPP access may include trusted non-3GPP access, e.g., WLAN and wireline access (e.g., fiber or cable, etc.).

The N3IWF 312 is a network function responsible for interworking the 3GPP core network and the untrusted non-3GPP access 322. Features of various embodiments may include one or more of: redirect user plane packets from the UE to the UPF 222 in the uplink and from the UPF 222 to the UE 218 in the downlink over the N3 interface, e.g., similar to S1-U interface in 3GPP based network which may be tunnel or non-tunnel based; manage and configure one or more non-3GPP access 322, e.g., WLAN-AP, via the Y2 interface; handle control plane signaling with the AMF 214 in the core network over the N2 interface, e.g., similar to S1-AP control plane signaling interface; forward N1 control plane signaling sending from the UE 218 to the AMF 214, e.g., similar to non-access stratum (NAS) signaling in 3GPP based network; and setup Nwu control plane signaling with the UE 218 via the WLAN-AP over the NWu interface, e.g., similar to radio resource control (RRC) signaling in 3GPP-based networks.

The GBSF 310 is a group based service function responsible for handling group policies, e.g., media format/type, group security parameters, groupcast transmission schedule, group management, etc. The GBSF 310 can be with the extended features in the PCF or a standalone network function. If the GBSF 310 is a standalone network function, it may interact with other network function, e.g. SMF, PCF, AMF, UDM. For example, it can request service from PCF 206, as shown in FIG. 2, for retrieving policies related to the UE, the group, access and mobility management, or session management. For another example, it can request service from SMF 216 to receive session status for a particular UE or a group of GBS.

The system architecture 300 separates control plane signaling messages and user plane data traffic in the core network and provides the following functions, in brief: a core network control plane function (CPF), the UPF 222, and the UDM 108. The CPF may include the AMF 214 for registration/connection/security context management, etc., and to provide routing policies to the RAN node. The CPF may also include the SMF 116 for determining routing policies for a service requested by an IoT device, configuring/reconfiguring routing policies on one or more impacted data gateways (DGWs). The UPF 222 may include one or more DGWs, provide network load information to the SMF 216, configure the routing policies at the impacted DGWs, and forward the traffic packets to the next DGW or data network 224 as configured in the routing policies. The UDM 208 functions as a subscription repository, and stores the device/service subscription information.

### A(2) High Level GBS Procedure

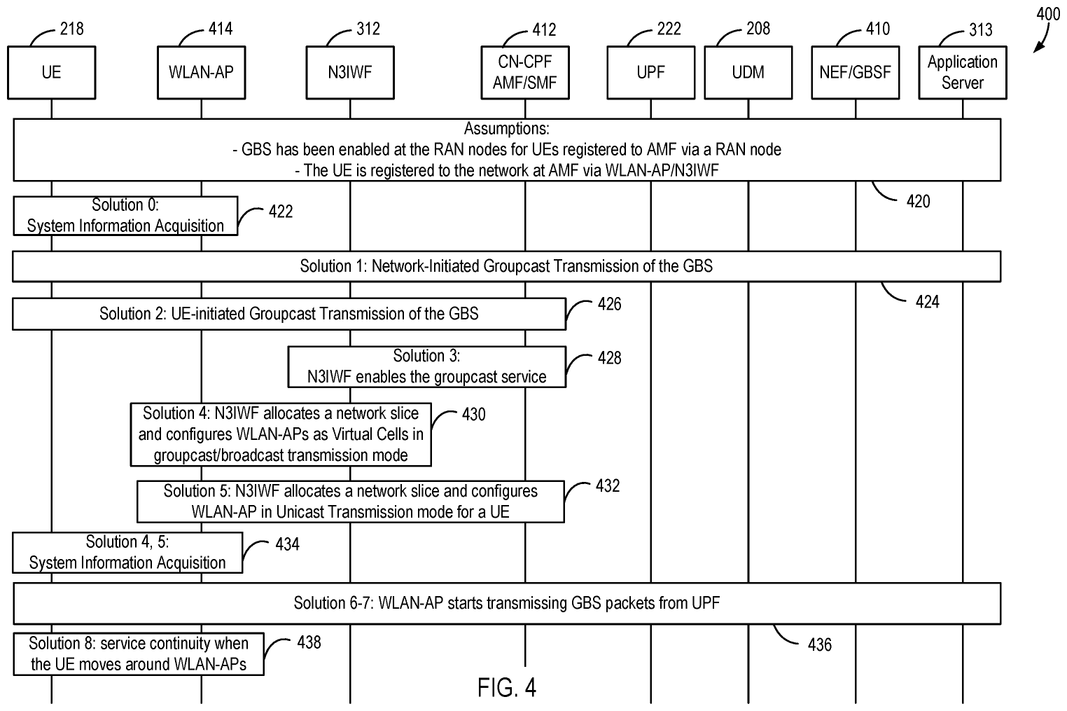

FIG. 4 is a flow diagram of a high level GBS procedure 400 according to certain embodiments. FIG. 4 shows that the following entities may be involved with various aspects of the high level GBS procedure 400: the UE 218, a WLAN-AP 414, the N3IWF 312, a CN-CPF 412, the UPF 222, the UDM 208, an NEF/GPSF 410, and the application server 313. Refer to FIG. 3. It should be noted that the CN-CPF 412 may include the AMF 214, the SMF 216, or both, either in a single entity or in separate entities. Similarly, the NEF/GPSF 410 may include one or both of the NEF 202 and the GBSF 310, either as a single entity or separate entities.

The illustrated high level GBS procedure 400 includes assumptions 420, a “Solution0” 422, a “Solution1” 424, a “Solution2” 426, a “Solution3” 428, a “Solution4” 430, a “Solution5” 432, a “Solution4, 5” system information acquisition 434, a “Solution6-7” 436, and a “Solution8” 438. Each of these elements will be discussed below.

The assumptions 420 include a first assumption that GBS has been enabled at the RAN nodes for UEs registered to the AMF 214 via a RAN node. The SMF 216 has instructed the UPF 222 to establish a packet data unit (PDU) session for the GBS. The PDU session for the groupcast may contain one or more IP flows indicated by IP flow IDs, wherein the PDU session is indexed by an PDU session ID. In certain embodiments, it is assumed that the PDU session ID is indicated along with IP flow IDs whenever applicable and each GBS is associated to at least one of the PDU session for the groupcast. This may be accomplished, for example, using the “Model A” or “Model B” approaches discussed below. The assumptions 420 also include a second assumption that the UE is registered to the network at the AMF 214 via the WLAN-AP 414 and/or the N3IWF 312.

### A(2)(a) System Information Acquisition (“Solution0”)

An issue (i.e., “Issue0”) regarding the high level GBS procedure shown in FIG. 4 is to define the system information sent by the network and acquired via the WLAN-AP 414 by the UE 218 before and after activating the GBS over the WLAN-AP 414. In one embodiment (i.e., “Solution0” 422), when the UE 218 that is registered to the 3GPP service via a WLAN-AP 414 requires a GBS of the application-ID, the UE 218 checks whether the system information shows that the GBS is activated for the WLAN access. In one embodiment, the UE 218 may receive the system information from the network via a registered 3GPP access (e.g., RAN node), wherein the system information is related to the activated GBS information which indicates the list of activated GBS and corresponding activation access types e.g., 3GPP access (e.g., RAN node), non-3GPP access (e.g., WLAN, wireline), or both. In one embodiment, the network sends the system information in both of 3GPP accesses and non-3GPP accesses, e.g. WLAN and wireline, in which the 3GPP access obtains the non-3GPP access information from the AMF which retrieves non-3GPP information from the N3IWF which manages one or more non-3GPP accesses.

The system information broadcast by the WLAN-AP 414 for a particular GBS service of an application-ID may include at least one of the following information: Application-ID, WLAN service types of the application, SSID(s)/ESSID/basic SSID(s) (BSSID(s)) of the WLAN-AP(s), virtual cell ID(s), and TGSID. The application-ID can be preconfigured at the device to identify the subscribed service. The WLAN service types of the application, e.g. inactive, broadcast, groupcast, unicast, may be based on the WLAN-AP's capability. The inactive service type indicates that the service is not activated yet, and the rest of the service types show the transmission mode of the activated service. Each virtual cell identified by a virtual cell ID may include at least one of WLAN-AP(s) with a same or different SSID. The virtual cell ID is a global unique ID, e.g., includes the N3IWF-ID and a temporary cell ID allocated by the N3IWF. For the WLAN-APs allocated with the same virtual cell ID, the system information of the specific service-ID is the same. The TGSID is associated with certain service areas, which may be represented by one or more virtual cell IDs via WLAN. For an authorized UE for the GBS, the UE can obtain a TGSID allocated by a GBSF from the application server 313.

In one embodiment (Option 1 of Solution0), if the WLAN service type of the application is indicated as unicast/broadcast, the UE 218 sends a N1 signaling message towards the AMF via the N3IWF 312 for starting the unicast transmission of the application, wherein the N1 message indicates at least one of the following information: application-ID; the temporary UE ID received during a network attachment procedure; and a service token received from the application server 313, wherein the token is used as the authorization for the unicast/broadcast service. The AMF may query the GBSF for verifying the service token. In a response message, the network provides at least one of the following information if the authorization is valid: the application-ID; a network slice ID of the requested service, in which the network slice ID is also stored at the N3IWF 312 for forwarding the groupcast service of the application ID; and the temporary UE service ID, which may be associated to the allocated network slice used for the UE.

In another embodiment (Option 2 of Solution0), if the WLAN service type of the application is indicated as groupcast, the UE 218 sends a request message for receiving the groupcast transmission of the application. The details are provided below (see Solution1 to Solution8).

### A(2)(b) Network-Initiated Groupcast Transmission of the GBS (Solution1)

Another issue (i.e., “Issue1”) regarding the high level GBS procedure shown in FIG. 4 is to define how the network activates groupcast services for UEs registered to the network via the WLAN-AP 414 and the N3IWF 312, including interaction before groupcast service request towards the AMF and interaction between the AMF and the N3IWF 312. One embodiment (i.e., “Solution1” 424) of the high level GBS procedure shown in FIG. 4 comprises a network-initiated groupcast service update for WLAN access. The UE 218 indicates at least one of the following information to the application server: access type sets as a WLAN; application-ID; TGSID if available and still valid; application user ID; temporary UE-ID allocated by AMF/N3IWF via an N3/N2 signaling message during a registration procedure; and location information including geographical coordinates (e.g., longitude and latitude), virtual cell ID which is indicated in the system information broadcasting by the network and/or SSID of the associated WLAN-AP.

Solution1.1: Following Solution1, if the location information is within the service area of the groupcast service that has not been activated, the application server 313 initiates a groupcast service update request to the network via the NEF operating at a network entity (e.g., the NEF/GBSF 410 shown in FIG. 4), wherein the request message indicates at least one of the following information: request type that indicates a service area update; location information for activating the group casting service identified by the application ID (e.g., geographical coordinates, virtual cell ID, SSID of associated WLAN-AP); authorized service area which may be identified by a Service Area ID (the application server may obtain this service area ID when receiving service authorization and starting the service); and/or the radio access technology type (e.g., LTE, NR (new radio), WLAN, wireline, etc.).

Solution1.2: Following Solution1.1, the NEF requests the UDM 208 for the authorization of the service area update with at least one of the following information: application ID; authorized service areas, which may be indicated as one or more service area IDs (SAIs); location information; and/or service to be updated (e.g., the radio access technology type and/or the service area).

Solution1.3: Following Solution1.2, in a response message, the NEF obtains at least one of the following information from the UDM 222: SAI(s); AMF address/port information; and/or SMF address/port information.

Solution1.3.1: Following Solution1.3, the NEF may send a query message, indicating SAI(s) and/or application ID, to a GBSF. In a response message, the NEF may get a TGSID for the SAI(s) of the application-ID.

Solution1.4: Following solution1.3.1, the NEF forwards the groupcast service update request to the AMF, wherein the request message includes at least one of the following information: TGSID SAI(s); preferred radio access technology (e.g., WLAN, LTE, wireline, etc.); and/or virtual cell ID.

Solution1.5: Following Solution1.4, if the WLAN is indicated as the preferred radio access technology, the AMF determines which N3IWF to request for enabling the groupcast service with at least one of the following groupcast service information: TGSID; UPF routing profile of the groupcast including groupcast IP flows ID and data gateway (DGW) address/port for the groupcast IP flows; SAI(s); and/or virtual cell ID.

Solution1.6: Following Solution1.5, the routing profile of the groupcast service with the TGSID is obtained by the AMF. In a first embodiment, the AMF obtains the routing profile from the NEF. In this embodiment, the NEF forwards the groupcast service update request to the SMF, wherein the request message includes at least one of the TGSID and the SAI(s). In a second embodiment, the AMF obtains the routing profile from the SMF. In this embodiment, the AMF queries SMF for the routing profile via the following two information received from the NEF: TGSID and SAI(s).

### A(2)(c) UE-Initiated Groupcast Transmission of the GBS (Solution2)

One embodiment (i.e., “Solution2” 426) of the high level GBS procedure shown in FIG. 4 comprises UE-initiated groupcast service update for WLAN access. The UE 218, for example, may receive system information that does not indicate the TGSID for the interested application identified by an application-ID, i.e., the groupcast service has not yet been activated at the WLAN-AP, or the system information shows that for the application-ID, the WLAN service types of the application indicates as inactive. Thus, the UE 218 may send an N1 signaling message as a service request to the AMF via the N3IWF 312, wherein the service request indicates at least one of the following information: application-ID for the interested groupcast service; and/or location information, e.g., virtual cell ID, SSID of the associated WLAN-AP, and/or geographical information. Alternatively, if the UE receives the system information related to the GBS in WLAN from 3GPP access, the UE 218 may send an N1 signaling message as a service request to the AMF via the 3GPP access, e.g. RAN node, wherein the request message indicates the interested GBS, the preferred access type for GBS, virtual cell ID, and SSID of the associated WLAN-AP.

Solution2.1: Following Solution2, the AMF may check whether the provided location information is in the authorized service area of the groupcast service. If needed, the AMF may query the N3IWF 312 for the location information of the WLAN-AP 414 based on the virtual cell ID and/or the SSID of the WLAN-AP. The AMF may check whether the provided TGSID is still valid or activated at the registered N3IWF 312 (parse from virtual cell ID). If the provided TGSID is invalid or inactivated at the AMF based on the stored groupcast context, or the provided location information is not within authorized service area, the AMF may send a direct message to the N3IWF 312 for redirecting to the another AMF that has provisioned the groupcast service.

Solution2.2: Following Solution2.1, if the AMF determines to activate the groupcast service as requested, the AMF indicates the N3IWF for enabling the groupcast service with the groupcast information as follows: application-ID; TGSID; UPF routing profile of the groupcast including groupcast IP flows ID and DGW address/port for the groupcast IP flows; groupcast service area information; and/or virtual cell ID(s).

Solution2.3: Following Solution2.2, the UPF routing profile of the groupcast service with the TGSID is obtained by the AMF. In one embodiment, the AMF obtains the UPF routing profile from the NEF. In this embodiment, the NEF forwards the groupcast service update request to the SMF, wherein the request message includes at least one of the TGSID and the SAI(s). In another embodiment, the AMF obtains the UPF routing profile from the SMF. In this embodiment, the AMF queries the SMF for the routing profile via the following two information received from the NEF: TGSID and SAI(s).

### A(2)(d) N3IWF Enables Groupcast Service (Solution3)

Another issue (i.e., “Issue2”)”) regarding the high level GBS procedure shown in FIG. 4 is to define how the N3IWF 312 enables the groupcast service when receiving the requested information from the AMF. One embodiment (i.e., “Solution3” 428) of the high level GBS procedure shown in FIG. 4 defines certain actions of the N3IWF 312. Following Solution1.5 or Solution2.3, when the N3IWF 312 receives the service request from the AMF, the N3IWF 312 determines to enable groupcast service at all or selected associated WLAN-APs for forwarding the groupcast IP packets. If the N3IWF 312 has IP multicast capability, the N3IWF 312 performs an IP multicast joining procedure with the AMF for the groupcast service by indicating the GBS identifier, N3IWF identifier, N3IWF IP address, port number used for the indicated GBS. The AMF informs the 312 N3IWF about the IP multicast address for the indicated GBS, groupcast IP flows ID and DGW address/port in UPF for the groupcast IP flows. If the N3IWF 312 does not support IP multicast capability, the N3IWF 312 skips IP multicast joining procedure with the AMF but registers its N3IWF identifier, the activated GBS identifier and subscribes groupcast service information updates from the AMF. The AMF reports the updates of the groupcast service to the N3IWF according to the subscribed reporting service request.

Solution3.1: Following Solution3, the N3IWF 312 stores the groupcast context including the information of the TGSID, groupcast IP flow ID, downlink DGW address/port of the groupcast IP flow, and one or more virtual cell IDs that has activated the groupcast service.

Solution3.2: Following Solution3.1, according to the authorized service area, the N3IWF 312 may determine to reconfigure one or more virtual cells among a number of WLAN-APs for the groupcast service identified by the TGSID.

Solution3.3: Following Solution3.2, the N3IWF 312 updates the system information to be broadcast, and sends system information to the corresponding WLAN-AP 414. The UE 218 may receive the notification of the system information changes and then acquires the system information. In addition, in one embodiment wherein the system information related to the GBS over non-3GPP access can be broadcast by 3GPP access, the N3IWF 312 provides the updated system information to the 3GPP access directly if there exists an interface or via AMF over N2.

### A(2)(e) N3IWF Handles Network Slice—Broadcast Solution (Solution4)

In one embodiment (i.e., “Solution4” 428) of the high level GBS procedure shown in FIG. 4, the N3IWF 312 handles a network slice for the requested groupcast service on a one or more connected WLAN-APs basis. That is, one N3IWF 312 manages one or more service groups in which each is with one or more connected WLAN-APs. Each service group is configured as one virtual cell. In simplicity, one N3IWF 312 can configure all connected WLAN-APs as one virtual cell. The N3IWF 312 sends Y2 signaling messages indicating the following information to all associated WLAN-APs: application-ID; WLAN service types indicated as broadcast/groupcast; TGSID if groupcast; virtual cell ID; updated system information to be broadcast for the groupcast service; synchronization information (e.g., obtain from the UPF in the user plane transmission or from the AMF in control plane signaling message); time schedule of the transmission; and/or allocated IPv4 Address pool/IPv6 prefix of the subnet.

Solution4.1: Following Solution4, the N3IWF 312 stores at least one of the following information for all or selected connected WLAN-APs: application-ID; TGSID; virtual cell ID; SSID/ESSID of the one or more WLAN-APs; allocated IPv4 Address pool/IPv6 prefix of the subnet; groupcast IP flows ID; and/or DGW address/port in UPF for the groupcast IP flows.

Solution4.2 (network slice): Following Solution4.1, the N3IWF 312 creates a network slice for the enabling groupcast service and sends at least one of the following information towards all or selected connected WLAN AP(s) over Y2: WLAN service types indicated as broadcast/groupcast; application-ID; TGSID; virtual cell ID; system information schedule; and/or allocated IPv4 Address pool/IPv6 prefix of the subnet.

Solution4.3 (WLAN AP action—system information): Following Solution4.2, after receiving the message sent from N3IWF 312, the WLAN-AP 414 starts to send system information to WLAN UE(s), wherein the system information includes at least one of the following information: application-ID; WLAN service types indicated as broadcast/groupcast; SSID(s)/ESSID/BSSID(s) of the WLAN-AP(s); virtual cell ID(s); and/or TGSID. In addition, in one embodiment that the system information related to the GBS over non-3GPP access can be broadcast by 3GPP access, the N3IWF 312 provides the updated system information to the 3GPP access directly if there exists an interface or via AMF over N2, wherein the system information includes at least one of the following information: application-ID; WLAN service types indicated as broadcast/groupcast; SSID(s)/ESSID/BSSID(s) of the WLAN-AP(s); virtual cell ID(s); and/or TGSID.

Solution4.4: Following Solution4.3, the UE 218 receiving the system information may send a Y1 message towards WLAN-AP 414 for associating with a particular SSID/ESSID/BSSID corresponding to a TGSID. In a response message, the WLAN-AP 414 may allocate an IP address to the UE 218 for the network slice of the groupcast. In one embodiment that the system information related to the GBS over non-3GPP access is broadcast by 3GPP access and the N3IWF 312 provides the updated system information to the 3GPP access, the UE 218 receiving the system information may send a N1 message indicating the SSID/ESSID/BSSID of the associated WLAN-AP, virtual cell ID, and the corresponding TGSID. In a response message, the AMF may provide the SSID/ESSID/BSSID of the WLAN-AP to the UE 218 for the network slice of the groupcast via WLAN.

Solution4.5: Following Solution4.4, the N3IWF 312 starts to forward the received groupcast data from the UPF 222 to the WLAN-AP 414 according to the stored routing policies.

### A(2)(f) N3IWF Handles Network Slice—Unicast Solution (Solution5)

In one embodiment (i.e., “Solution5” 430) of the high level GBS procedure shown in FIG. 4, the N3IWF 312 handles a network slice for the requested groupcast service at an individual UE basis. When the N3IWF 312 receives the service request from the AMF, the N3IWF 312 determines to enable groupcast service in a unicast transmission mode for forwarding the IP packets to the individual UE 218 that requested the service. The N3IWF 312 responds the AMF for the UE 218, which is identified by a temporary UE-ID allocated by AMF/N3IWF via the N3/N2 signaling message during the registration procedure, to use unicast transmission of the groupcast service. The AMF may query the SMF for setting up a unicast routing path for the N3IWF 312 and get the information about the unicast IP flows ID and DGW address/port in the UPF 222 for the unicast IP flows. The N3IWF 312 stores the UE context for the unicast transmission and then further sends Y2 signaling messages indicating the following information to all associated WLAN-APs: application-ID; WLAN service types indicated as unicast; virtual cell ID; system information to be broadcast for the groupcast service; and/or allocated IPv4 Address pool/IPv6 prefix of the subnet.

Solution5.1 (GBS context): Following Solution5, when the N3IWF 312 receives the service request from the AMF with the unicast information of the UPF 222, the N3IWF 312 stores at least one of the following information in a GBS context associated to an application-ID: application-ID; virtual cell ID; SSID of the one or more WLAN-APs; IP-flow IDs; DGW address/port in the UPF 222 for the IP flows; and/or temporary UE-ID for the GBS.

Solution5.2 (system information and WLAN-AP actions): Following Solution5.1, after receiving the message sent from the N3IWF 312, the WLAN-AP 414 enables unicast mode and starts to send system information to WLAN UE(s), wherein the system information includes at least one of the following information: application-ID; WLAN service types indicates as unicast; SSID of the WLAN-AP; and/or virtual cell ID.

Solution5.3: Following Solution5.1, based on the stored groupcast context for an application-ID, the N3IWF 312 starts to forward the received groupcast data from the UPF 222 to the WLAN-APs requiring the groupcast service via unicast transmission toward the WLAN-registered UE(s).

Solution 5.4: Following Solution5.1, the N3IWF 312 may share the unicast transmission locally towards different UEs, which may request the unicast transmission of the TGSID later via WLAN-AP(s) by using the same routing profiles of the UPF subject to a specific TGSID.

### A(2)(g) WLAN AP Transmits Groupcast Packets of the GBS (Solution6)

Another issue (i.e., “Issue3”) regarding the high level GBS procedure shown in FIG. 4 is to define how the N3IWF 312 enables user plane transmission via the UPF 222 and transmits groupcast packets of the GBS service over the WLAN-AP 414.

In one embodiment (Solution6.1-Y2, broadcast mode transmission), following Solution4.3, if the transmission mode indicates as broadcast and no TGSID is provided, the WLAN-AP 414 uses a broadcast channel to transmit the packets, indicating with flow ID and application-ID over Y1.

In another embodiment (Solution6.2-Y2, groupcast mode transmission), following Solution4.3, if the transmission indicates as groupcast, the WLAN-AP 414 uses a broadcast channel to transmit the packets, indicating with flow ID, TGSID, and application-ID, over Y1. Only the attached UEs within the authorized service group have the group information, TSGID, to receive the groupcast transmission.

In another embodiment (Solution6.3-Y2, unicast mode transmission), following Solution5.4, if the transmission indicates as unicast and temporary UE IDs in the service group are provided, the WLAN-AP 414 uses unicast transmission to the indicated UEs in the service group.

### A(2)(h) UE Receives Groupcast Packets of the GBS (Solution7)

Another issue (i.e., “Issue4”) regarding the high level GBS procedure shown in FIG. 4 is to define how the UE 218 starts to receive the groupcast packets sent by the associated WLAN-AP 414. In one embodiment (Solution7), when the UE 218 receives the system information of the GBS service, the UE 218 follows the schedule information to start receiving the packets sent with the following options.

In one embodiment (Option1 of Solution7—broadcast mode), if WLAN service types indicate as broadcast, the UE 218 receives the GBS data packets, which is indicated with an application-ID, IP flow ID, from the broadcast channel over Y1.

In another embodiment (Option2 of Solution7—groupcast mode), if WLAN service types indicate as groupcast, the UE 218 receives the GBS data packets, which is indicated with an application-ID, IP flow ID, and a TGSID, from the broadcast channel over Y1.

In another embodiment (Option3 of Solution7—unicast mode), if WLAN service types indicate as unicast, the UE 212 receives the GBS data packets, which is indicated with an application-ID, IP flow ID, and a temporary UE IDs, from the unicast channel over Y1.

### A(2)(i) Service Continuity of the GBS (Solution8)

Another issue (i.e., “Issue5”) regarding the high level GBS procedure shown in FIG. 4 is to define how the network provides service continuity for the groupcast service between non-3GPP accesses. To provide service continuity of the GBS, according to one embodiment (Solution8), the N3IWF 312 configures one or more WLAN-AP(s) as one virtual cell. When moving around the service coverage of the WLAN-APs, the UE 218 can maintain the WLAN connections for the GBS without interrupting the service as long as the UE 218 stays at the same virtual cell. In one embodiment that resolves the issue about how the network provides service continuity for the groupcast service between 3GPP and non-3GPP access, the AMF can be the anchor network function to direct the UE capable of available access types to use a particular access for the groupcast service by signaling N1 message via 3GPP access or N3IWF to the UE. In another embodiment, the UE can receive UE route selection policies (URSP) related to the groupcast service indicated by the TGSID and the access types and can select the applicable access for the GBS accordingly.

For example, all associated WLAN AP(s) of the virtual cell may be configured with the following options: with an unique SSID/ESSID across the N3IWF; a particular channel may be configured for the groupcast service; or the associated WLAN-AP(s) need to share the same security settings, e.g. security mode, algorithm, shared keys, and renewal intervals. In this case, the N3IWF 312 stores the mapping among SSID, the BSSID)(s) of the WLAN-AP(s) and the virtual cell-ID: TGSID-virtual cell ID #I-{SSID1, SSIDI, . . . }-ESSID.

Further, for some applications with location dependent service policies/requirements, the N3IWF 312 may manage a number of virtual cell IDs for the GBS identified with application-ID. Although the UE 218 can continue the GBS when moving to different cell after association, some level of service interruption may occur.

Optimization may be applicable by configuring a WLAN-AP with multiple SSIDs associated to different virtual cell IDs. When a UE stays at such a WLAN-AP coverage, it can associate to multiple SSIDs.

For a TGSID, at least one WLAN-AP can be allocated with one virtual cell ID by the N3IWF. The N3IWF stores the set of the virtual cell ID(s) for an TGSID.

The UE capable of WLAN access can acquire system information with the following options: from broadcast messages sent by the associated WLAN-AP over Y1; or from a Nwu signaling message (similar to RRC message in EPS) to acquire on-demand system information for a TGSID.

### A(3) Additional Examples of Pervasive Connectivity for GBS

Example 1A may include an apparatus comprising means for determining one or more configuration parameters for one or more access stratum network entities as a virtual cell identified by a virtual cell identifier (ID) that includes one or more of a unique service set ID (SSID)/extended SSID (ESSID) across a control plane network entity, a particular channel for service, or one or more security settings; and means for communicating at least some of the configuration parameters to the one or more access stratum network entities.

Example 2A may include the subject matter of Example 1A or some other example herein, wherein the one or more access stratum network entities include one or more wireless local area network access points (WLAN-APs).

Example 3A may include the subject matter of any one of Examples 1A-2A or some other example herein, wherein the security settings include one or more of a security mode, one or more shared keys, or one or more renewal intervals.

Example 4A may include the subject matter of any one of Examples 1A-2A or some other example herein, wherein the means for configuring one or more access stratum network entities includes means for configuring the one or more access stratum network entities with multiple SSIDs associated to different virtual cell IDs.

Example 5A may include the subject matter of any one of Examples 1A-4A or some other example herein, further comprising means for managing one or more virtual cells for a group based service identified with an application ID and a temporary group service based ID (TGSID).

Example 6A may include the subject matter of Example 5A or some other Example herein, further comprising means for storing a mapping between the virtual cell ID, the TGSID, the application ID, the SSID/ESSID, and a basic service set ID (BSSID) of the one or more access stratum network entities.

Example 7A may include the subject matter of any one of Examples 1A-6A or some other example herein, further comprising means for providing updated system information with one or more of an application ID, a WLAN service type, a WLAN-AP identifier, a virtual cell ID, or a TGSID.

Example 8A may include the subject matter of any one of Examples 1A-7A or some other example herein, wherein the means for determining one or more configuration parameters for one or more access stratum network entities as a virtual cell identified by a virtual cell ID and the means for communicating at least some of the configuration parameters are included in a non-3GPP interworking function (N3IWF) or a portion or implementation thereof.

Example 9A may include an apparatus comprising means for identifying one or more configuration parameters in a signal from a non-3GPP interworking function (N3IWF); and means for communicating with a user equipment (UE) based at least in part on the configuration parameters.

Example 10A may include the subject matter of Example 9A or some other example herein, wherein the configuration parameters include one or more of a virtual cell identifier (ID), a service set ID (SSID), an extended SSID (ESSID), a channel for service, or one or more security settings.

Example 11A may include the subject matter of Example 10A or some other example herein, wherein the security settings include one or more of a security mode, one or more shared keys, or one or more renewal intervals.

Example 12A may include the subject matter of any one of Examples 9A-11A or some other example herein, wherein the means for identifying one or more configuration parameters and the means for communicating with a UE are included in a wireless local area network access point (WLAN-AP) or a portion or implementation thereof.

Example 13A may include a method and apparatus of group based service (GBS) provisioning for pervasive connectivity in a mobile network is for a first control plane network entity (N3IWF) to configure service areas by configuring one or more access stratum network entities (wireless local area network access points (WLAN-APs)) as one virtual cell identified by a virtual cell ID with at least one of the following parameters: a unique service set ID (SSID)/extended SSID (ESSID) across the first network entity (N3IWF), a particular channel for the service, the security settings.

Example 14A may include the subject matter of Example 13A or some other example herein, wherein the security settings include at least one of the following parameters: security mode, algorithm, shared keys, and renewal intervals.

Example 15A may include the subject matter of Example 13A or some other example herein, wherein the first network entity may configure the access stratum network entity with multiple SSIDs associated to different Virtual Cell IDs for a user equipment (UE) to associate to multiple SSIDs when staying within the coverage.

Example 16A may include the subject matter of Examples 13A or 14A or some other example herein, wherein the first network entity may manage a number of Virtual Cells for a group based service identified with an application-ID and a temporary group service based ID (TGSID).

Example 17A may include the subject matter of Example 16A or some other example herein, wherein the first network entity stores the mapping among the SSID/ESSID, the basic service set ID (BSSID)(s) of the WLAN-AP(s), the virtual cell-ID(s), the application ID, and the temporary group based service ID.

Example 18A may include the subject matter of Example 14A or some other example herein, wherein the first network entity provides updated system information with at least one of the following parameters: Application-ID, WLAN service type indicated as broadcast/groupcast/unicast, SSID(s)/ESSID/basic service set ID (BSSID)(s) of the WLAN-AP(s), Virtual Cell ID(s), and TGSID.

Example 19A may include the subject matter of Example 18A or some other example herein, wherein a UE can acquire system information from broadcast messages sent by the associated WLAN-AP or from a signaling message towards the first network entity to acquire on-demand System information for the TGSID.

Example 20A may include a method and apparatus of group based service (GBS) provisioning for pervasive connectivity in a mobile network is for a first network entity (N3IWF) to create a network slice for the enabling service, stores at least one of the following information, and send signaling messages indicating at least one of the following information to one or more associated access stratum network entities (WLAN APs): Application-ID, WLAN service types, Temporary group based ID if using groupcast transmission, Virtual Cell ID, Updated System Information to be broadcast for the groupcast service, Synchronization information, Time schedule of the transmission, Allocated 1Pv4 Address pool/IPv6 prefix of the subnet.

Example 21A may include the subject matter of Example 20A or some other example herein, wherein the synchronization information is obtained from a second network entity (user plane function (UPF)) in the user plane transmission or from a third network entity (access and mobility management function (AMF)) in control plane signaling message.

Example 22A may include the subject matter of Example 20A or some other example herein, wherein the WLAN service types provide the transmission mode used for the service and include broadcast, groupcast, and unicast.

Example 23A may include the subject matter of Example 21A or some other example herein, wherein the first network entity provides updated system information with at least one of the following parameters: Application-ID, WLAN service type, SSID(s)/ESSID/BSSID(s) of the WLAN-AP(s), Virtual Cell ID(s), and TGSID.

Example 24A may include a method and apparatus of group based service (GBS) provisioning for pervasive connectivity in a mobile network is for a first network entity (N3IWF) to receive the service request from a second network entity (AMF), and determine to enable GBS, identified by an application ID and a temporary group based service ID (TGSID), at one or more associated access stratum network entities (WLAN APs) for forwarding the groupcast IP packets.

Example 25A may include the subject matter of Example 24A or some other example herein, wherein if the first network entity is with IP multicast capability, it performs IP multicast joining procedure with the second network entity for the service, wherein the second network entity informs the first network entity about the groupcast transmission information in a third network entity.

Example 26A may include the subject matter of Example 25A or some other example herein, wherein the groupcast transmission information includes the groupcast IP flows ID and Data Gateway (DGW) address/port in the third network entity (UPF) for the groupcast IP flows.

Example 27A may include the subject matter of Example 26A or some other example herein, wherein the first network entity stores the service context including the information of the TGSID, groupcast IP flow ID, Downlink DGW address/port of the groupcast IP flow, one or more virtual cell IDs that has activated the groupcast service.

Example 28A may include the subject matter of Example 27A or some other example herein, wherein according to the authorized service area, the first network entity may determine to reconfigure one or more virtual cells among a number of access stratum network entity (WLAN-APs) for the groupcast service identified by the TGSID.

Example 29A may include the subject matter of Example 28A or some other example herein, wherein the first network entity updates the system information to be broadcast, and sends system information to the corresponding WLAN AP. The UE may get the notification of the system information changes and then acquire the system information.

Example 30A may include an apparatus to: create a network slice to enable a group based service (GBS); store configuration information that includes one or more of an application-ID, a wireless local area network (WLAN) service type, a temporary group based ID, synchronization information, or a virtual cell ID; and send the configuration information to one or more access stratum network entities.

Example 31A may include the subject matter of Example 30A or some other example herein, wherein the access stratum network entities are WLAN access points (APs).

Example 32A may include the subject matter of any one of Examples 30A-31A or some other example herein, wherein the apparatus is to obtain the synchronization information from a second network entity in a user plane transmission or a third network entity in a control plane signaling message.

Example 33A may include the subject matter of any one of Examples 30A-32A or some other example herein, wherein the WLAN service type indicates a transmission mode used for service.

Example 34A may include the subject matter of any one of Examples 30A-33A or some other example herein, wherein the apparatus is also to provide updated system information that includes one or more of an application-ID, a WLAN service type, a service set identifier (SSID), an extended SSID (ESSID), a basic service set ID (BSSID), a virtual cell ID, or a temporary group based service ID (TGSID).

Example 35A may include the subject matter of any one of Examples 30A-34A or some other example herein, wherein the apparatus is a non-3GPP interworking function (N3IWF) or a portion or implementation thereof.

Example 36A may include an apparatus to: identify one or more configuration parameters in a signal from a non-3GPP interworking function (N3IWF); and communicate with a user equipment (UE) based at least in part on the configuration parameters, wherein the configuration parameters include one or more of an application-ID, a wireless local area network (WLAN) service type, a temporary group based ID, synchronization information, or a virtual cell ID.

Example 37A may include the subject matter of Example 36A or some other example herein, wherein the WLAN service type indicates a transmission mode used for service.

Example 38A may include the subject matter of Example 37A or some other example herein, wherein the transmission mode is one of broadcast, groupcast, or unicast.

Example 39A may include the subject matter of any one of Examples 36A-38A or some other example herein, wherein the signal is a first signal and the apparatus is also to identify updated system information in a second signal from the N3IWF.

Example 40A may include the subject matter of Example 39A or some other example herein, wherein the updated system information includes one or more of an application-ID, a WLAN service type, a service set identifier (SSID), an extended SSID (ESSID), a basic service set ID (BSSID), a virtual cell ID, or a temporary group based service ID (TGSID).

Example 41A may include the subject matter of any one of Example 36A-30A or some other example herein, wherein the apparatus is a WLAN access point (AP) or a portion or implementation thereof.

Example 42A may include a method comprising: identifying or causing to identify a service request in a signal from an access and mobility management function (AMF); enabling or causing to enable a group based service (GBS) based at least in part on the service request; and identifying or causing to identify the GBS with an application ID and a temporary group based service ID (TGSID).

Example 43A may include the subject matter of Example 42A or some other example herein, further comprising performing or causing to perform an internet protocol (IP) multicast joining procedure with the AMF.

Example 44A may include the subject matter of any one of Examples 42A-43A or some other example herein, further comprising identifying or causing to identify a groupcast IP flow ID and a data gateway (DGW) address/port for a groupcast IP flow.

Example 45A may include the subject matter of any one of Examples 42A-44A or some other example herein, further comprising storing or causing to store a service context that includes a TGSID, a groupcast IP flow ID, a downlink DGW address/port of a groupcast IP flow, and one or more virtual cell IDs that has an activated groupcast service.

Example 46A may include the subject matter of any one of Examples 42A-45A or some other example herein, further comprising reconfiguring or causing to reconfigure one or more virtual cells among a number of access stratum network entities for a groupcast service identified by the TGSID.

Example 47A may include the subject matter of any one of Examples 42A-46A, wherein the method is performed by a non-3GPP interworking function (N3IWF) or a portion or implementation thereof.

Example 48A may include a method comprising: identifying or causing to identify one or more configuration parameters in a signal from a non-3GPP interworking function (N3IWF); and communicating or causing to communicate with a user equipment (UE) based at least in part on the configuration parameters, wherein the configuration parameters include one or more of an application-ID, a wireless local area network (WLAN) service type, a temporary group based ID, synchronization information, or a virtual cell ID.

Example 49A may include the subject matter of Example 48A or some other example herein, wherein the WLAN service type indicates a transmission mode used for service.

Example 50A may include the subject matter of Example 49A or some other example herein, wherein the transmission mode is one of broadcast, groupcast, or unicast.

Example 51A may include the subject matter of any one of Examples 48A-50A or some other example herein, wherein the signal is a first signal and the apparatus is also to identify updated system information in a second signal from the N3IWF.

Example 52A may include the subject matter of Example 51A or some other example herein, wherein the updated system information includes one or more of an application-ID, a WLAN service type, a service set identifier (SSID), an extended SSID (ESSID), a basic service set ID (BSSID), a virtual cell ID, or a temporary group based service ID (TGSID).

Example 53A may include the subject matter of any one of Example 48A-52A or some other example herein, wherein the method is performed by a WLAN access point (AP) or a portion or implementation thereof.

Example 54A may include a signal comprising group based service (GBS) configuration information that includes one or more of a unique service set identifier (SSID)/extended SSID (ESSID) across a non-3GPP interworking function (N3IWF), a particular channel for the GBS, or security settings.

Example 55A may include the subject matter of Example 54A or some other example herein, wherein the security settings include one or more of a security mode, one or more shared keys, or one or more renewal intervals.

Example 56A may include an apparatus comprising means to perform one or more elements of a method described in or related to any of examples 1A-55A, or any other method or process described herein.

Example 57A may include one or more non-transitory computer-readable media comprising instructions to cause an electronic device, upon execution of the instructions by one or more processors of the electronic device, to perform one or more elements of a method described in or related to any of examples 1A-55A, or any other method or process described herein.

Example 58A may include an apparatus comprising logic, modules, or circuitry to perform one or more elements of a method described in or related to any of examples 1A-55A, or any other method or process described herein.

Example 59A may include a method, technique, or process as described in or related to any of examples 1A-55A, or portions or parts thereof.

Example 60A may include an apparatus comprising: one or more processors and one or more computer readable media comprising instructions that, when executed by the one or more processors, cause the one or more processors to perform the method, techniques, or process as described in or related to any of examples 1A-55A, or portions thereof.

Example 61A may include a signal as described in or related to any of examples 1A-55A, or portions or parts thereof.

Example 62A may include a signal in a wireless network as shown and described herein.

Example 63A may include a method of communicating in a wireless network as shown and described herein.

Example 64A may include a system for providing wireless communication as shown and described herein.

Example 65A may include a device for providing wireless communication as shown and described herein.

### B. Groupcast Services Provisioning in 5G Systems

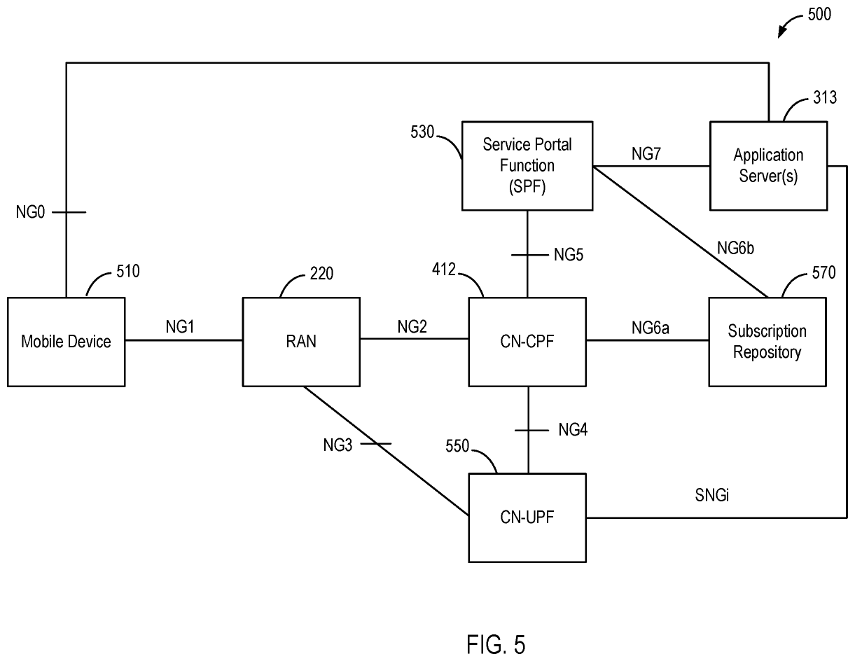

In support of groupcast, a framework of provisioning group-based services in a software-defined network (SDN) mobile network may include the following features: allowing internet protocol (IP) multicast/non-IP multicast capable RAN node for providing groupcast service; and allowing an application server with media storage to request services for controlling a groupcast session via the SMF 216 in a core network (CN) control plane function (CPF) (see FIG. 5), as well as for sending data directly over the UPF 222 in a secure manner.

FIG. 5 is a block diagram of an example system architecture 500 according to one embodiment. As shown the example system architecture 500 includes a mobile device 510, a RAN 220, a service portal function (SPF) 530, a CN-CPF 412, a CN-UPF 550, application server(s) 313, and a subscription repository 570. The corresponding interfaces NG0, NG1, NG2, NG3, NG4, NG5, NG6a, NG6b, NG7, and SNGi are also shown.

The system architecture shown in FIG. 5 may fit the 5G system architecture in FIG. 2, for example, and certain elements may be described as follows. The UDM 208 corresponds to the subscription repository 570. The AMF 214 and the SMF 216 may be in the CN-CPF 412. The NEF 202 or the PCF 206 may have similar features as the SPF 530, wherein the NEF 202 may store and retrieve information from a data storage function (DSF) over an N19 reference point (not shown) for network external and network internal exposure. The AMF 214 may use the services exposed by the PCF 206 or the NEF 202 based on the operator deployment.

When considering groupcast services provisioning in 5G/5G+ services, there may be the various models. In a first example model (e.g., Model A), third party service providers manage their own data storage, e.g., in media centers, and rely on groupcast services provided by mobile network operators (MNOs) for transporting data over the mobile network. For example, a third party service provider, e.g., Facebook® or Instagram®, may request a groupcast service, e.g., sharing live video streaming, over the mobile network for a group of users as requested. Embodiments for this use case may, for example, as compared to the LTE-MBMS transmission via broadcast multicast service center (BM-SC), reduce the potential delay caused by BM-SC preloading between the application server(s) 313 and the BM-SC, and may be more scalable and interoperable groupcast services across the mobile networks.

In a second example model (e.g., Model B), third party service providers may use data storage services to buffer data to be transported via groupcast services provided by MNOs. For example, for commercial video broadcasting services, the third party service provider may request storage service and store the commercial video data storage function in the mobile network. Depending on the service request or service schedule, the groupcast service may be provided to users.

Embodiments described herein may be designed to meet, for example, the abovementioned criteria. Also, referring to a 5G architecture in, for example, FIG. 1, embodiments herein may include aspects related to Model B described above and may describe how a DSF provides service and exposes its service to the third party service provider (application server) providing groupcast services, how the network performs session control on a centralized DSF as media center, and/or how the network performs session control on distributed DSFs.

In certain embodiments, the NEF 202, which may act as an interworking function between the application server(s) 313 and the AMF 214 and/or SMF 216 (e.g., in the CN-CPF 412 shown in FIG. 5), may expose group-based services for application server(s) 313, for handling a packet data unit (PDU) groupcast session.

In certain embodiments, the DSF provides data storage services along with group-based services, as indicated for abovementioned Model B.

In certain embodiments, the PDU groupcast session may be configured with or without IP multicast transmission, which depends on the IP multicast capability support in the impacted RAN nodes, CN-CPF 412, data gateways (DGW) in the UPF 222, and the NEF 202. A PDU groupcast session without applying IP multicast transmission may provide more rigorous control on the traffic load of the impacted DGWs, which may result in better load balancing among DGWs in the UPF 222.

In certain embodiments, two mechanisms of PDU groupcast session control may be used to accommodate various services criteria by adapting to the traffic characteristics of different group based services, e.g., vehicle-to-everything (V2X), group message delivery for software updates, etc.

In certain embodiments, the user plane data packets sent from the application server 313 to the DSF/boundary DGW in the UPF 222 and/or impacted RAN nodes may be secured by an encryption/integrity mechanism.

Compared to the MBMS based group communication system in an evolved packet system (EPS), for example, embodiments described herein may have various advantages. For example, the MBMS architecture may rely on specialized BM-SC/MBMS-gateway (GW)/multi-cell/multicast coordination entity (MCE) deployments in the EPS. Thus, certain embodiments herein describe a unified framework that may provision group-based services, which may be applicable for handling a PDU groupcast session with or without IP multicast depending on the IP multicast capability at the RAN/CN-CPF/DGWs in UPF/NEF and network conditions/configurations. That is, for example, with or without applying IP multicast, both mechanisms may share the same SDN network architecture in provisioning a group-based service.

As another example advantage, along with Model A, embodiments described herein may further include DSF and services to support groupcast services as Model B described above. Both Models may enrich the support of versatile groupcast services.

As another example, with the capability to handle groupcast session regardless of whether supporting IP multicast capability for RAN nodes and core network entities, embodiments described herein may make broad deployment possible and in economical manners.

As another example, embodiments described herein may reduce the signaling overhead for configuring and managing the PDU groupcast session.

As another example, certain embodiments that include PDU groupcast session establishment without using IP multicast may provide more rigorous traffic load control of the DGWs in the UPF, which may achieve better load balancing among DGWs in the UPF.

As yet another example, a PDU groupcast session control mechanism may be adaptive to different traffic characteristics of the group-based services, e.g., V2X, group message delivery for software updates, etc.

Further, certain embodiments described herein may be efficient and flexible in addressing, for example, the aforementioned issues in an EPC architecture.

### B(1) Example System Architecture with DSF

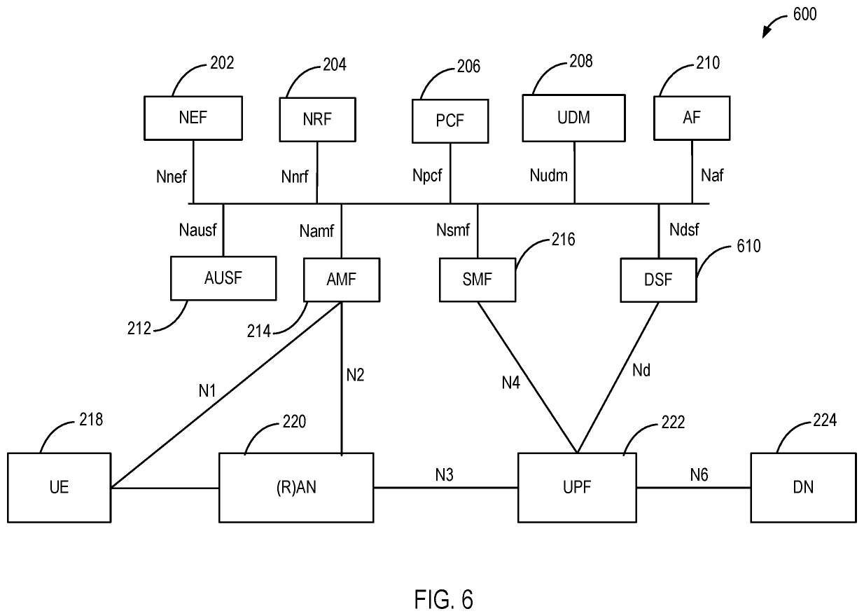

FIG. 6 is a block diagram of an example system architecture 600 configured according to certain embodiments described herein. Embodiments described herein may include service-based interfaces within the control plane, including all of the elements and interfaces shown in FIG. 2, and additionally may include a DSF 610 deployment option, as shown in FIG. 6. In reference point deployment, the DSF 610 may be interfaced through an Ndsf reference point with the UDM 208 directly or indirectly via the NEF 202. Further, the DSF 610 may interface with the UPF 222 via an Nd reference point. Certain embodiments herein describe features for the addition of the DSF 610.

Embodiments herein may support the Model B described above (and other models), for groupcast services in, for example, the SDN-based network architecture in 5G systems, which may have separate control plane and user plane functions. The SMF 216 may have flexibility to split and/or merge IP flows based on the quality of service (QoS), traffic loads of DGWs in UPF 222, service areas, etc. As such, compared to the tunnel-based MBMS architecture in the EPS, the complexity may be reduced with, for example, the separation of the control plane and user plane functions.

The details of the DSF 610, PDU groupcast session establishment, session control mechanism, and the security mechanism are described in the following embodiments.

### B(1)(a) Data Storage Function

In the DSF 610, according to certain embodiments, there may be a number of data base servers (DBSs) distributed in the core/edge network. The data base servers include DSF information, e.g., deployed physical geographical location for the data base server, address information, and/or available storage space, that may be stored and maintained at the UDM 208 or a domain name system (DNS) server. If the DNS server is deployed and functioned as a data storage management function (DSMF), the UDM 208 and/or the NEF 202 may query the DSMF about the allocated DSF information with the service request indicating, for example, at least one of the following information: requested storage capacity; serving area of the group service; and/or attached point of the application server 313 making the service request. The DSF 610 may update its status with the above information with the UDM/DNS server periodically or in an event-trigger based manner, e.g., if there is a change of the storage space within X then storage space increase or reduction.

In a response message for the data storage request message sent by the NEF 202, at least one of the following information may be provided: DBS address info, represented as, for example, address/port or a fully qualified domain name (FQDN) or a unique identity (DSF-ID) in the registered public land mobile network (RPLMN); assigned data storage ID (DS-ID); allowed data storage capacity; and/or valid period.

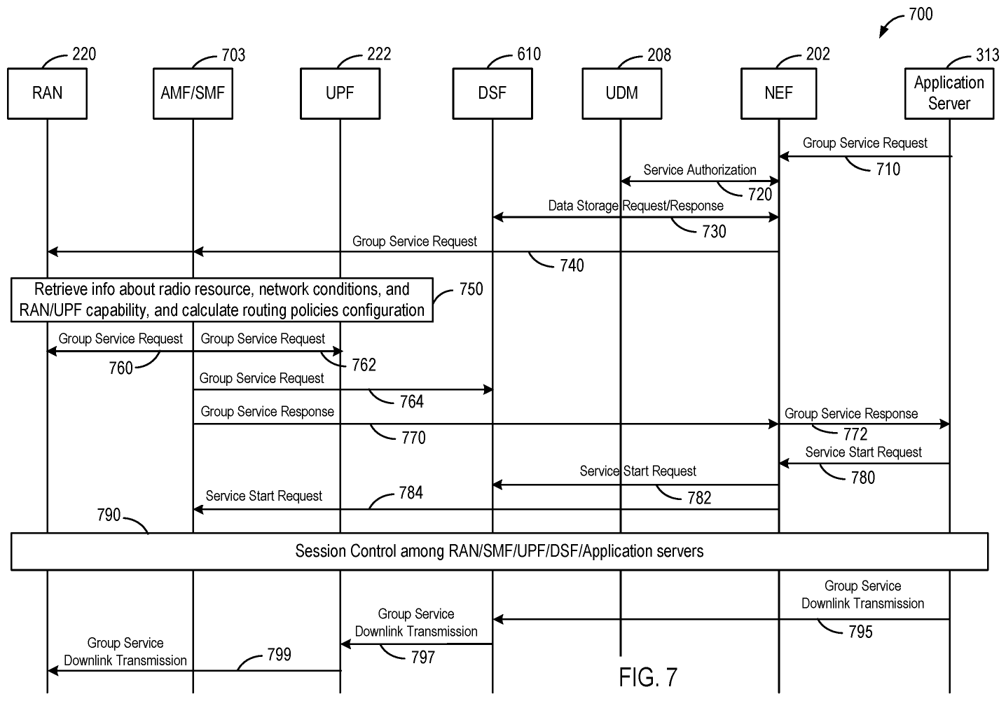

Further, embodiments described in connection with, for example, steps 710, 720, 730, 740, and 790 in FIG. 7, in which steps 750, 760, 762, 764, 770, and 772 are skipped, may be a separate procedure to get the data storage service via the NEF 202.

### B(1)(b) PDU Groupcast Session Establishment

Embodiments described in connection with, for example, steps 760 and 762 in FIG. 7 may establish a PDU groupcast session. Depending on, for example, the IP multicast capability in the impacted RAN nodes/CN-CPF/UPF, and network load conditions, the SMF 216 (e.g., in the CN-CPF 412 shown in FIG. 5) may determine which type of the PDU groupcast session may be used, e.g., with or without using IP multicast, for provisioning group-based service that may be requested by the application server 313.

The SMF 216 may have, for example, the following options to configure routing polices on the DGWs in the UPF 222 with or without using IP multicast.

### B(1)(b)(i) Using IP Multicast

In one embodiment, a PDU multicast session may be created for the joined RAN nodes with IP multicast capability. The SMF 216 in the CN-CPF 412 may configure the routing policy for the IP multicast session on one or more DGWs in the CN-UPF 550. The DGWs may check the IP multicast address and may determine how to forward the group service packets. If, for example, there is a change of the joined RAN node, the routing policies may, or may need to, be reconfigured for the impacted DGWs. The IP multicast group may be managed by SPF 530 or the CN-CPF 412.

### B(1)(b)(ii) without Using IP Multicast

In another embodiment, the SMF 216 in CN-CPF 412 may configure routing policies on one or more DGWs in the UPF 222. In the routing policies, some of the DGWs may be configured to forward the same received traffic flow towards different targets, e.g., destined to different DGWs or the RAN nodes. For example, the packet flow may be split by replicating the received packets from the source input and forwarded to two or more target outputs, which may be towards to different RAN nodes. The PDU groupcast session may be set up with one or more multiple flows between the boundary DGW and the destined RAN nodes depending on the QoS requirements. For example, the traffic flow may be split at the boundary DGW or any intermediate DGWs.

### B(1)(c) PDU Groupcast Session Control Mechanism

In the EPS, the broadcast multicast service center (BMSC) may indicate start or stop of the MBMS bearer service in the session control message towards MBMS-GW/mobility management entity (MME)/eNodeB. In order for adapting to versatile group-based services that may use different traffic patterns and characteristics, different session control mechanism may be applied as follows (referring to the example message flows shown in FIG. 7): Option 1 uses an embodiment described in connection with, for example, steps 740 or 780, 782, 784 shown in FIG. 7, for policy based session control; and Option 2 uses embodiments described in connection with, for example, steps 795, 797, 799 shown in FIG. 7, with direct control from the application server 313.

More specifically, Option 1 is schedule policy based, which may save or reduce some signaling overhead among the application server/SPF/CN-CPF/CN-UPF/RAN. The session control policy may be provided among impacted control plane functions. For some group based services, the transmission may be short and predicable such that it may be beneficial, for example, that the session control message indicates additional information. For example, the duration of the downlink transmission and the traffic load of the downlink transmission, e.g., transmission rate, packet size, etc. The downlink transmission may, for example, stop when the duration is due. As another example, the period of the downlink transmission, and the average traffic load of the downlink transmission may be provided, e.g., the downlink transmission may be scheduled periodically. The downlink transmission may, for example, stop when the duration is due.

Option 2 is direct control based, in which the application server 313 may send a session control message, including, for example, session start/update/halt/resume/stop/synchronization information (e.g., time stamps), directly towards control plane functions using control plane signaling. Optionally, the UPF 222 may send sync data packets.

### B(1)(d) Security Mechanism for User Plane Encryption/Integrity

The user plane packet transmission between the application server 313, the DSF 610, the UPF 222, and the impacted RAN 220 nodes may be secured by encrypting the data packet using, for example, one or more security parameters for encryption. Also, the security parameter for integrity protection may be used between the NEF 202 and the application server 313. For example, the security function in the control plane may use a first security parameter provided by the UDM 208 and may generate a second security parameter for encrypting/decrypting the data packet of the group-based service. The second security parameter may be sent to application server 313 via the NEF 202 and impacted RAN 220 nodes, wherein the security parameter may be unique or shared among the AMF 214 and/or SMF 216 in CN-CPF 412 controlled domain. If a different encryption mechanism is applied between the application server 313 and the DSF 610 and/or the UPF 222, a third security parameter may be generated and sent to the impacted function (e.g., DSF/UPF/application server). A fourth security parameter may be generated based on the first security parameter and used for protecting control plane signaling integrity.

### B(2) Example Message Flows (Model A)

Aspects of the Model A message flow are described with reference to FIG. 5. For Model A, the SPF 530, which act as an interworking function between the application servers and the CN-CPF412, provides group based service policies for handling PDU groupcast session. The PDU groupcast session can be configured with or without IP multicast transmission, which depends on the IP multicast capability support in the impacted RAN 220 nodes, the CN-CPF 412, the CN-UPF 550, and the SPF 530. The PDU groupcast session without applying IP multicast transmission provides more rigorous control on the traffic load of the impacted DGWs, which results in better load balancing among DGWs in CN-UPF 412. The PDU groupcast session control mechanism provides more information in order for adapting to the traffic characteristics of different group based services, e.g. V2X, group message delivery for software updates, etc. The user plane data packets sent from the application server to the impacted RAN 220 nodes are secured by an encryption/integrity mechanism.

A centralized SDN network controller has direct control over one or more data gateways, e.g., via an openflow protocol, in reflect to the real-time network conditions. With the separation of the control plane and the user plane, the CN-CPF 412 directly configures the routing policies on one or more DGWs in the CN-UPF 550 which can then enforces the routing policies on the packet flows via the NG4 interface. Excepting for forwarding packets flow from one source input to the one target output at the DGW, the DGW can duplicate the packets from one source input to one or more target output, i.e., splitting one packet flow into more than one forwarding packet flows. For providing group base services in the SDN based network architecture, the capability of splitting flows not only can bring the flexibility at the session management, but also can avoid the complexity as in the tunnel-based MBMS architecture in EPS.

For the message flow, the application server 313 sends a group service request to the SPF 530, including at least one of the following information: group service ID; application server ID; service area indicated by service area ID or geographical areas; service request type indicated as group; and service profile including service time, traffic load, priority, maximum/average/minimum transmission rate, latency, group size (number of device in the group).

The SPF 530 requests for service authorization from the subscription repository 570 in a service authorization request message with at least one of the above information. In a response message, the subscription repository 570 provides the information including at least one of the following: group service ID; group service policies according to the service subscription; security parameters for IP packets encryption/integrity; subscribed service area information of the group based service which may be a geographical area or a service area ID (SAI), wherein the group service policies may include the QoS parameters (e.g. MBR, latency requirements), etc. SAI is maintained via O&M and may be mapped to a SAI different from the configured SAI sending from the application server 313.

The SPF 530 configures the group policy and allocate a TGSID associated to the group service context created for the group service. For example, the group service policies indicates the traffic characteristic of the group based service. Also, the SPF 530 stores the security parameters in the group service context.

According to the SAI, the SPF 530 sends group service request to the impacted CN-CPF 412 with at least one of the following information: TGSID; group service area ID (GSAI); security parameters; mapped SAI; the policy of session management; and/or group service area information, wherein the group service area information may be a mapped SAI, or a service area ID (SAD. The mapped SAI is provided by the third network entity or calculated by the first network entity. The policy of session management may include IP multicast capability of the first network entity, and the service profile.

According to the mapped SAI, the CN-CPF 412 queries the impacted RAN 220 nodes for the radio resource, and IP multicast capability as well as one or more DGWs in CN-UPF 550 for the network conditions and IP multicast capability. Alternatively, the IP multicast capability of the DGWs and the RAN 220 nodes are configured/stored at the CN-CPF 412. Accordingly, the CN-CPF 412 determines if applying IP multicast for the group based service and configures routing polices.

For PDU groupcast session establishment, the CN-CPF 412 informs the CN-UPF 550 and the impacted RAN 220 nodes with the routing policies identified by the TGSID. In addition, the CN-CPF 412 determines the port number and the IP address of the boundary DGW for the group service identified by the TGSID. The RAN 220 node receiving the group service request indicating the enabling of the IP multicast performs IP multicast join procedure towards CN-CPF 412. The CN-CPF 412 then organizes the IP multicast group and configures the routing policies accordingly. In addition, the CN-CPF 412 may store the security parameters in the group service context if requested by the CN-UPF 550 when checking integrity, if needed. Further, the CN-CPF 412 forwards the security parameters to the RAN 220 nodes for decrypting the IP packets identified by the TGSID. That is, the IP packets sent from the application server 313 to the impacted RAN 220 nodes are secured by the encryption mechanism (discussed below).

The CN-CPF 412 sends a response message to the SPF 530 and the SPF 530 forwards the information to the application server 313, wherein the response message includes the information of the boundary DGW IP address and port number, security parameters, and TGSID. There may be more than one boundary DGW information, i.e., the application server 313 may transmit the same data traffic via more than one boundary DGW with different IP address and/or port number.

The application server 313 then starts session control messages towards the SPF 530 and CN-CPF 412.

The CN-CPF 412 informs the RAN 220 nodes and the CN-UPF 550 for the session control message with session control parameters. The detail of the session control methods and the parameters is depicted in the following description of the PDU groupcast session control mechanism.

The application server 313 encrypts the content of the IP traffic packets, marks TGSID in IP packet header, and starts group service downlink transmission via the assigned DGW IP address/port number, wherein the DGWs receiving the IP packets marked with TGSID enforces the routing rules to duplicates and forwards the IP packets accordingly. The RAN 220 node uses the stored security parameters to decrypt the packet identified by the TGSID.

Similar to the PDU groupcast session establishment discussed above, within the service areas, the impacted nodes need to support IP multicast capability. Depending on the IP multicast capability in the impacted RAN nodes/CN-CPF/CN-UPF, and network load conditions, the CN-CPF 412 determines which type of the PDU groupcast session is used for provisioning group-based service requested by the application server.

The CN-CPF 412 has the following options to configure routing polices on the DGWs in CN-UPF 550 with or without using IP multicast. In a first alternative that uses using IP multicast, a PDU multicast session is created for the joined RAN nodes with IP multicast capability. The CN-CPF 412 configures routing policy for the IP multicast session on one or more DGWs in CN-UPF 550. The DGWs checks the IP multicast address and determines how to forward the group service packets. Whenever there is a change of the joined RAN node, the routing policies needs to be reconfigured for all the impacted DGWs. The IP multicast group may be managed by SPF 530 or CN-CPF 412.

In a second alternative without using IP multicast, the CN-CPF 412 configures routing policies on one or more DGWs in CN-UPF 550. In the routing policies, some of the DGW may be configured to forward the same received traffic flow towards different target, e.g., destined to different DGWs or the RAN nodes. That is, the packet flow is split by replicating the received packets from the source input and forwarded to two or more target outputs, which maybe towards to different RAN node. The PDU groupcast session is setup with one or more multiple flows between the boundary DGW and the destined RAN nodes. For example, the traffic flow may be split at the boundary DGW or any intermediate DGWs.

Regarding the PDU groupcast session control mechanism, in EPS, the BMSC indicates start or stop of the MBMS bearer service in the session control message towards MBMS-GW/MME/eNodeB. However for some group based services, the transmission is short and predicable, it would be beneficial that the session control message can indicate additional information for the downlink transmission. For an example, in the session start message, the duration of the downlink transmission may be provided and the traffic load of the downlink transmission, e.g. transmission rate, packet size, etc. In this case, the downlink transmission stops when the duration is due. The DGW may save some guard time before enforcing the routing policy. Also, with the traffic load information, the CN-UPF 412 can regulate the traffic loads among DGWs better. Such session control mechanism is suitable for software update via group message delivery with one scheduled transmission.

For another example, in the session start message, the period of the downlink transmission, and the average traffic load of the downlink transmission are provided, i.e. the downlink transmission is scheduled periodically. These information is suitable for V2X message delivery. The application server 313 collects the required information from the devices in the group and provides the information in the periodical and groupcast manner.

Thus, with abovementioned information, some signaling overheads are reduced among the application server/SPF/CN-CPF/CN-UPF/RAN.

Regarding the security mechanism for user plane encryption/integrity, the user plane packet transmission between the application server 313 and the impacted RAN 220 nodes is secured by encrypting the data packet. The CN-CPF 412 uses a first security parameter provided by the subscription repository for the requested group based service and generates a second security parameter for decrypting the data packet of the group based service. The second security parameter is sent to application server 313 via the SPF 530 and impacted RAN 220 nodes can be a unique or shared among the CN-CPF 412 controlled domain. In addition, the CN-CPF 412 may store a third security parameter in the group service context for protecting user plane data integrity provided by the subscription repository for the requested group based service. The third security parameter is used when being requested by the CN-UPF 550 for checking integrity.

### B(3) Example Message Flows (Model B)

FIG. 7 is a high-level flow diagram of an application server 313 initiated group service procedure 700 according to certain embodiments. The procedure 700 may be used, for example, with Model B discussed above. With respect to FIGS. 5, 6, and 7 the procedure 700 is executed by the application server 313, the NEF 202, the UDM 208, the DSF 610, the UPF 222, the AMF 214 and/or the SMF 216 (shown in FIG. 7 as AMF/SMF 703), and the RAN 220.

At step 710, the application server 313 sends a group service request to the NEF 202, including, for example, at least one of the following information: group service ID; application server ID; service area indicated by service area ID (SAI) or geographical areas; service request type indicated as group; service profile including service time, traffic load, priority, maximum transmission rate, average transmission rate, minimum transmission rate, latency, and group size (number of devices in the group); and DSF request including required or requested data storage capacity, expected access responsive time, DS-ID, and DSF-ID (represented as, e.g., address/port, FQDN or a unique identity in the RPLMN if obtained but not expired).

At step 720, the NEF 202 may request for service authorization from the UDM 208 in a service authorization request message with, for example, at least one of the above information. In a response message, the UDM 208 may provide the information including, for example, at least one of the following: a TGSID; impacted AMF/SMF address information; group service policies according to the service subscription; security parameters for IP packets encryption/integrity protection; subscribed service area information of the group-based service which may be a geographical area or a SAI; DSF information; and/or valid time for the group service. The group service policies may include the QoS parameters (e.g., maximum bit rate (“MBR”), latency requirements), etc. SAI may be maintained via operation and maintenance (“O&M”) and may be mapped to an SAI (“mapped SAI”) different from the configured SAI sending from the application server 313. The DSF information may include DSF address info (which may be represented, for example, as address/port or an FQDN or a DSF-ID in the RPLMN), DS-ID, allowed data storage capacity, or valid period.

Optionally, the NEF 202 may query a group service function (GSF) for the group-based service based on, for example, the information received from the UDM 208 in the response message. The GSF may allocate a TGSID associated to the group service context created for the group service. Also the GSF may store the group service policy or retrieve it from the PCF/UDM. For example, the group service policies may indicate the traffic characteristic of the group-based service. Also, the GSF may store the security parameters in the group service context. The security parameters usage and the security mechanism may be described in embodiments herein.

At step 730, the NEF 202 may send a data storage request to a data base identified by, for example, the assigned DSF-ID, wherein the request may include, for example, a DS-ID, an allowed data storage capacity, a valid period, or an application server ID (e.g., address, FQDN). In the response message, the DSF 610 may indicate, for example, the successful/failure of the creation of the data storage.

At stop 740, according to, for example, the SAI, the NEF 202 may send a group service request to the impacted AMF/SMF in CN-CPF with, for example, at least one of the following information: TGSID; group service area ID (“GSAI”); security parameters; the policy of session management; and/or group service area information. The group service area information may be, for example, a mapped SAI, or an SAI, in which the mapped SAI may be, for example, provided by the UDM 208 or, for example, calculated by the NEF 202. The policy of session management may include, for example, IP multicast capability of the RAN 220 node/DGWs, and the service profile.

At step 750, according to, for example, the mapped SAI, the AMF in CN-CPF may query the impacted RAN 220 nodes for, for example, the radio resource, and IP multicast capability, as well as, for example, one or more DGWs in UPF 222 for the network conditions and IP multicast capability. Alternatively, the IP multicast capability of the DGWs and the RAN 220 nodes may be, for example, configured or stored at SMF in CN-CPF. Accordingly, the SMF in CN-CPF may determine if applying IP multicast for the group based service, and then may calculate the routing polices.

At steps 760 an 762, the SMF in CN-CPF may send group service request to inform, for example, the impacted DGWs in UPF and the impacted RAN nodes with, for example, the routing policies identified by the TGSID.

In addition, the SMF in CN-CPF may optionally determine, for example, the port number and the IP address of the boundary DGW for the group service identified by the TGSID, which may be used in embodiments described in connection with step 790 for the direct access of the application server 313 if allowed by the NEF 202. At step 764, the SMF in CN-CPF or NEF may provide, for example, the information of the port number and the IP address of the boundary DGW to the allocated DSF 610 if allowing the direct access of the DSF 610 from the application server. The SMF may inform the boundary DGW about the assigned DSF 610 information, and may inform the DSF 610 about the boundary DGW information. The direct access of the DSF 610 may be a separated procedure by the application server 313 for managing, for example, the data storage of the DSF 610, e.g., upload/update/delete the data storage.

The SMF in CN-CPF may organize, for example, the IP multicast group and may configure the routing policies accordingly. If the IP multicast is supported by the RAN 220 node, the NEF 202 may send the group service request indicating, for example, the enabling of the IP multicast and the associated TSGID. The RAN 220 node may, for example, in response, perform, for example, IP multicast join procedure towards AMF/SMF in CN-CPF.

If the IP multicast is not supported by the RAN 220 node, the NEF 202 may send the group service request indicating, for example, the routing policies of the groupcast. The RAN 220 node may store the groupcast and may enforce the broadcasting transmission, e.g., MBMS, when receiving groupcast packets, e.g., identified by TSGID, from the UPF 222.

In addition, the AMF/SMF in CN-CPF may store the security parameters in the group service context. The DGW in the CN-UPF may request, for example, for the security parameters when checking integrity if needed. Further, the AMF/SMF in CN-CPF may forward the security parameters to the RAN 220 nodes for, for example, decrypting the IP packets identified by the TGSID, for example. For example, the IP packets sent from the application server to the impacted RAN 220 nodes may be secured by, for example, the encryption mechanism. The security mechanism may be as described in embodiments herein.

At steps 770 and 772, the CN-CPF may send a response message to the NEF 202 and the NEF 202 may forward the information to the application server 313, wherein the response message may include, for example, at least of the information: TGSID; the security parameters; the DSF-ID; DS-ID; allowed QoS; or volume, which may be used in, for example, embodiments described in connection step 790.

At steps 780, 782, and 784, optionally, the application server 313 may send service start request message that may indicate, for example, TGSID, towards the NEF 202, and the NEF 202 may forward the message towards AMF/SMF in CN-CPF and DSF 610.

At step 790, the application server 313 may conduct session control directly via the NEF 202, and the NEF 202 may forward the session control message towards AMF/SMF/RAN nodes. For example, the AMF in CN-CPF may inform the RAN nodes and the SMF in CN-CPF may inform one or more DGWs in UPF with the session control message with session control parameters, which may include, for example, session start/update/halt/resume/stop/synchronization information (e.g., time stamps). Embodiments herein may describe session control and the parameters, for example, in embodiments described in connection with the abovementioned PDU groupcast session control mechanism.

At steps 795, 797, and 799, the DSF 610 may send IP traffic packets towards boundary DGW. Optionally, the application server 313 may send data transmission towards the DSF 610 with, for example, a specific DSF-ID and the DS-ID.

The DSF/boundary DGW/SMF and the RAN node may need to store the security parameters. The following may be examples for securing the downlink data traffic. In a first option, the transaction between the 610 DSF and the RAN may be secured by one set of encryption parameters. In this case, for example, the DSF 610 may send encrypted IP traffic packets towards boundary DGW. In a second option, the transaction between the DSF 610 and boundary DGW, as well as between boundary DGW and the RAN 220, may be secured differently. The security parameters may be maintained, for example, by the AMF/SMF in CN-CPF.

Further, the DSF/boundary DGW may, for example, mark TGSID in IP packet header, and may start group service downlink transmission via, for example, the assigned DGW IP address/port number, wherein the DGWs receiving the IP packets marked with TGSID may enforce the routing rules to duplicates and may forward the IP packets accordingly. The RAN node may use the stored security parameters to, for example, decrypt the packet identified by the TGSID.

The security control mechanism may be applied, for example, between the application server 313 and the DSF/UPF/RAN node. For example, the application server 313 may encrypt the content of the IP traffic packets, marks TGSID in IP packet header before transmission. The DSF may use the stored security parameters to, for example, decrypt the packet identified by the TGSID.

### B(4) Additional Examples of Groupcast Services Provisioning

Example 1B may include a network exposure function (NEF) comprising: means to identify a received group service request from an application server; a means to request, based, at least in part, on the received group service request, a service authorization from a unified data management (UDM) in a service authorization message; and a means to identify a received response message from the UDM, in response to the service authorization message.

Example 2B may include the NEF of Example 1B and/or some other Example herein, wherein the group service request includes a group service ID, an application server ID, a service area, a service request type indicated as a group, a service profile, or a data storage function (DSF) request.

Example 3B may include the NEF of Example 2B and/or some other Example herein, wherein the service area includes a service area ID (SAI) or a geographical area.

Example 4B may include the NEF of Example 2B and/or some other Example herein, wherein the service profile includes a service time, a traffic load, a priority, a maximum transmission rate, an average transmission rate, a minimum transmission rate, a latency, or a group size.

Example 5B may include the NEF of Example 4B and/or some other Example herein, wherein the group size includes a number of devices in the group.

Example 6B may include the NEF of Example 2B and/or some other Example herein, wherein the DSF request includes a required data storage capacity, an expected access responsive time, a data storage ID (DS-ID), or a DSF-ID.

Example 7B may include the NEF of Example 6B and/or some other Example herein, wherein the DSF-ID includes an address, a port, a fully qualified domain name (FQDN), or a unique identity in a registered public land mobile network (RPLMN).

Example 8B may include the NEF of Example 1B and/or some other Example herein, wherein the response message from the UDF includes a temporary group service ID (TGSID), an access and mobility function (AMF)/session management function (SMF) address information, a group service policy according to a service subscription, a security parameter for internet protocol (IP) packet encryption, a subscribed service area information of a group based service, DSF information, or a valid time for a group service.

Example 9B may include the NEF of Example 8B and/or some other Example herein, wherein the group service policy may include a quality of service (QoS) parameter.

Example 10B may include the NEF of Example 9B and/or some other Example herein, wherein the QoS parameters include a maximum bit rate (MBR) or a latency requirement.

Example 11B may include the NEF of Example 9B and/or some other Example herein, wherein the SAI is maintained through operation and maintenance (O&M), and wherein the SAI is mapped to an SAI (mapped SAI) different than an SAI provided by an application server.

Example 12B may include the NEF of Example 9B and/or some other Example herein, wherein the DSF information includes DSF address info, an assigned DS-ID, an allowed data storage capacity, or a valid period.

Example 13B may include the NEF of Example 12B and/or some other Example herein, wherein the DSF address info is represented as an address, a port, an FQDN, DSF-ID in an RPLMN.

Example 14B may include the NEF of Example 8B and/or some other Example herein, wherein the subscribed service area information of the group based service includes a geographical area or an SAI.

Example 15B may include the NEF of Example 1B and/or some other Example herein, further comprising: a means to query a group service function (GSF) for the group based service based, at least in part, on the information received from the UDM in the response message.

Example 16B may include the NEF of Example 1B and/or some other Example herein, further comprising: a means to transmit based, at least in part, on the response message from the UDM, to a DSF a data storage request; and a means to identify a response message from the DSF.

Example 17B may include the NEF of Example 16B and/or some other Example herein, wherein the data storage request includes DS-ID, an allowed data storage capacity, a valid period, or an application server ID.

Example 18B may include the NEF of Example 16B and/or some other Example herein, wherein the response message from the DSF indicates a successful creation of a data storage or a failure of the creation of the data storage.

Example 19B may include the NEF of Example 1B and/or some other Example herein, further comprising: a means to transmit, based, at least in part, on the response message from the UDM, a group service request to a control network control plane function (CN-CPF); a means to identify a received response message from the CN-CPF; and a means to transmit, to the application server, information related to the received response message from the CN-CPF.

Example 20B may include the NEF of Example 19B and/or some other Example herein, wherein the group service request includes a TGSID, a group service area ID (GSAI), one or more security parameters, a policy of session management, or group service area information.

Example 21B may include the NEF of Example 20B and/or some other Example herein, wherein the group service area information includes a mapped SAI or an SAI

Example 22B may include the NEF of Example 21B and/or some other Example herein, wherein the UMD provides the mapped SAI.

Example 23 may include the NEF of Example 2B land/or some other Example herein, wherein the NEF calculates the mapped SAI.

Example 24B may include the NEF of Example 20B and/or some other Example herein, wherein the policy of session management includes a radio access network (RAN) node IP multicast capability, a data gateway (DGW) IP multicast capability, or a service profile.

Example 25B may include the NEF of Example 19B and/or some other Example herein, wherein the received response message from the CN-CPF includes a TGSID, a security parameter, a DSF-ID, a DS-ID, an allowed QoS, or a volume.

Example 26B may include the NEF of Example 19B and/or some other Example herein, further comprising: a means to identify a received service start request message from the application server; a means to transmit the received service start message to a CN-CPF; and a means to transmit the received service start message to a DSF.

Example 27B may include the NEF of Example 26B and/or some other Example herein, wherein the service start message includes a TGSID.

Example 28B may include a CN-CPF comprising: a means to transmit a query to a RAN node based, at least in part, on a mapped SAI; a means to transmit a query to a DGW, based, at least in part, on the mapped SAI; and a means to identify an IP multicast capability of the RAN node.

Example 29B may include the CN-CPF of Example 28B and/or some other Example herein, wherein the query to the RAN node includes a radio resource query or an IP multicast capability query.

Example 30B may include the CN-CPF of Example 28B and/or some other Example herein, wherein the query to the DGW includes a network condition query or an IP multicast capability query.

Example 31B may include the CN-CPF of Example 28B and/or some other Example herein, further comprising: a means to store the IP multicast capability of the RAN node.

Example 32B may include the CN-CPF of Example 28B and/or some other Example herein, further comprising: a means to establish the IP multicast capability of the RAN node.

Example 33B may include the CN-CPF of Example 28B and/or some other Example herein, further comprising: a means to determine whether an IP multicast for group-based service is applied; a means to calculate a routing policy; and a means to transmit a group service request, the group service request to inform a DGW and a RAN node about the routing policy.

Example 34B may include the CN-CPF of Example 33B and/or some other Example herein, wherein a routing policy enables a NEF to transmit a group service request, wherein the group service request includes an indication of an enabled IP multicast and an associated TSGID, if an IP multicast is supported by a RAN node; and transmit the group service request, wherein the group service request includes a routing policy of a groupcast, if the IP multicast is not supported by the RAN node.

Example 35B may include the CN-CPF of Example 33B and/or some other Example herein, wherein the routing policies enable the RAN to perform an IP multicast join procedure towards an AMF/SMF, if the RAN node supports an IP multicast; and store a groupcast, if the RAN node does not support the IP multicast; and further to enforce a broadcasting transmission, if the RAN node does not support the IP multicast.

Example 36B may include the CN-CPF of Example 35B and/or some other Example herein, wherein the broadcast transmission is a multimedia broadcast multicast service.

Example 37B may include the CN-CPF of Example 28B and/or some other Example herein, further comprising: a means to determine a port number and an IP address of a DGW for a group service identified by a TGSID; a means to transmit the port number and the IP address of the DGW to a DSF; and a means to transmit DSF information to the DGW.

Example 38B may include the CN-CPF of Example 28B and/or some other Example herein, further comprising: a means to receive security parameters from a DGW; a means to store the security parameters in a group service context; and a means to transmit the security parameters to a RAN node.

Example 39B may include a CN-CPF comprising: a means to identify a received session control message from a NEF; a means to inform a RAN node regarding the received session control message; and a means to inform a DGW regarding the received session control message.

Example 40B may include the CN-CPF of Example 39B and/or some other Example herein, wherein the received session control message enables an application server to conduct a session control through the NEF.

Example 41B may include the CN-CPF of Example 40B and/or some other Example herein, wherein the session control message includes a session control parameter.

Example 42B may include the CN-CPF of Example 41B and/or some other Example herein, wherein the session control parameter includes a session start, a session update, a session halt, a session resume, a session stop, or session synchronization information.

Example 43B may include the CN-CPF of Example 42B and/or some other Example herein, wherein the session synchronization information includes a time stamp.

Example 44B may include a DSF comprising: a means to transmit IP traffic packets to a DGW; a means to mark a TGSID in an IP packet header; and a means to start a group service downlink transmission through a DGW IP address.

Example 45B may include the DSF of Example 44B and/or some other Example herein, further comprising: a means to identify received IP traffic packets from an application server.

Example 46B may include the DSF of Example 45B and/or some other Example herein, wherein the IP traffic packets include a DSF-ID or a DS-ID.

Example 47B may include the DSF of Example 45B and/or some other Example herein, wherein the IP traffic packets are encrypted based on a set of encryption parameters maintained by the DSF.

Example 48B may include the DSF of Example 47B and/or some other Example herein, wherein the TGSID enables the DGW to enforce rules, and wherein the DGW is to duplicate the IP traffic packets, and wherein the DGW is to forward the IP packets to a RAN node based, at least in part, on the TGSID.

Example 49B may include the DSF of Example 48B and/or some other Example herein, wherein the RAN node decrypts the IP packet identified by the TGSID based, at least in part, on the set of encryption parameters.

Example 50B may include the DSF of Example 44B and/or some other Example herein, wherein the IP traffic packets are encrypted based on a set of encryption parameters maintained by a CN-CPF.

Example 51B may include an apparatus to: identify a received message related to a group-based service from a first network entity; and transmit, based, at least in part, on the received message, to a second network entity a response message related to the group-based service.

Example 52B may include the apparatus of Example 51B and/or some other Example herein, wherein the group-based service is a groupcast session control service.

Example 53B may include the apparatus of Example 52B and/or some other Example herein, wherein the first network entity is an application server, and wherein the received message is a group service request.

Example 54B may include the apparatus of Example 53B and/or some other Example herein, wherein the second network entity is a UDM, and wherein the response message is a service authorization message.

Example 55B may include the apparatus of Example 54B and/or some other Example herein, wherein the apparatus is further to identify a received response message from the UDM. in response to the service authorization message.

Example 56B may include the apparatus of Example 52B and/or some other Example herein, wherein the apparatus is a server that provides a network exposure function.

Example 57B may include the apparatus of Example 51B and/or some other Example herein, wherein the group-based service is a groupcast session establishment service.

Example 58B may include the apparatus of Example 57B and/or some other Example herein, wherein the first network entity is a NEF, and wherein the received message is a group service request.

Example 59B may include the apparatus of Example 58B and/or some other Example herein, wherein the second network entity is a RAN node, and wherein the response message is an IP multicast query.

Example 60B may include the apparatus of Example 59B and/or some other Example herein, wherein the apparatus is further to: organize an IP multicast group, based, at least in part, on the IP multicast query; and establish a routing policy, based, at least in part, on the IP multicast query.

Example 61B may include the apparatus of Example 57B and/or some other Example herein, wherein the apparatus is a server that provides a CN-CPF that includes an AMF and a SMF.

Example 62B may include the apparatus of Example 51B and/or some other Example herein, wherein the group-based service is a groupcast data storage service.

Example 63B may include the apparatus of Example 62B and/or some other Example herein, wherein the first network entity is a NEF, and wherein the received message is a data storage request.

Example 64B may include the apparatus of Example 63B and/or some other Example herein, wherein the second network entity is the NEF, and wherein the response message is an indication of a success of a creation of a data storage or a failure of the creation of the data storage.

Example 65B may include the apparatus of Example 64B and/or some other Example herein, wherein the apparatus is further to: encrypt, based, at least in part, on a successful creation of the data storage, IP data packets; and transmit encrypted IP data packets to a DGW.

Example 66B may include the apparatus of Example 62B and/or some other Example herein, wherein the apparatus is a server that provides a data storage function.

Example 67B may include a method of controlling a groupcast session, the method comprising: identifying, or causing to identify, a received response message, wherein the received response message includes an SAI; and transmitting, or causing to transmit, based, at least in part on the SAI, a group service request.

Example 68B may include the method of Example 67B and/or some other Example herein, wherein identifying, or causing to identify, the received response message includes identifying or causing to identify the received response message from a UDM.

Example 69B may include the method of Example 68B and/or some other Example herein, further comprising: transmitting a group authorization request to the UDM.

Example 70B may include the method of Example 67B and/or some other Example herein, further comprising: identifying, or causing to identify, a received group service request from an application server.

Example 71B may include the method of Example 67B and/or some other Example herein, wherein transmitting, or causing to transmit, based, at least in part on the SAI, the group service request includes transmitting, or causing to transmit, based, at least in part on the SAI, the group service request to a CN-CPF.

Example 72B may include the method of Example 71B and/or some other Example herein, further comprising: identifying, or causing to identify, a received reply message from the CN-CPF.

Example 73B may include the method of Example 67B and/or some other Example herein, wherein the response message includes a DSF-ID, the method further comprising: transmitting, or causing to transmit, based, at least in part on the DSF-ID, a data storage request to a DSF.

Example 74B may include a method of establishing a groupcast session, the method comprising: identifying, or causing to identify, a received group service request, wherein the group service request includes a mapped SAI; and transmitting, or causing to transmit, based, at least in part on the mapped SAI, an IP multicast query.

Example 75B may include the method of Example 74B and/or some other Example herein, wherein identifying, or causing to identify, the received group service request includes identifying, or causing to identify, the received group service request from a NEF.

Example 76B may include the method of Example 74B and/or some other Example herein, wherein transmitting, or causing to transmit, based, at least in part on the mapped SAI, the IP multicast query includes transmitting, or causing to transmit, based, at least in part on the mapped SAI, the IP multicast query to a RAN node.

Example 77B may include the method of Example 76B and/or some other Example herein, further comprising: organizing, based, at least in part, on the IP multicast query to the RAN node, an IP multicast group; and establishing a routing policy, based at least in part, on whether the RAN node supports the IP multicast.

Example 78B may include the method of Example 77B and/or some other Example herein, wherein establishing the routing policy, based at least in part, on whether the RAN node supports the IP multicast includes causing, if the RAN node supports the IP multicast, a NEF to send a group service request indicating an enabling of the IP multicast.

Example 79B may include the method of Example 77B and/or some other Example herein, wherein establishing the routing policy, based at least in part, on whether the RAN node supports the IP multicast includes causing, if the RAN node supports the IP multicast, the RAN to perform an IP multicast join procedure.

Example 80B may include the method of Example 77B and/or some other Example herein, wherein establishing the routing policy, based at least in part, on whether the RAN node supports the IP multicast includes causing, if the RAN node does not support the IP multicast, a NEF to send a group service request indicating a groupcast routing policy.

Example 81B may include the method of Example 77B and/or some other Example herein, wherein establishing the routing policy, based at least in part, on whether the RAN node supports the IP multicast includes causing, if the RAN node does not supports IP multicast, the RAN to store a groupcast and enforce a broadcasting transmission.

Example 82B may include a method of providing data storage for a groupcast session, the method comprising: identifying, or causing to identify, a received data storage request; and transmitting, or causing to transmit, in response to the data storage request, an indication of data storage creation success.

Example 83B may include the method of Example 82B and/or some other Example herein, wherein identifying, or causing to identify, the received data storage request includes identifying, or causing to identify, the received data storage request from a NEF.

Example 84B may include the method of Example 83B and/or some other Example herein, wherein transmitting, or causing to transmit, in response to the data storage request, the indication of data storage creation success includes identifying, or transmitting, or causing to transmit, in response to the data storage request, the indication of data storage creation success to the NEF.

Example 85B may include the method of Example 82B and/or some other Example herein, further comprising: storing a set of encryption parameters; encrypting IP traffic packets, based, at least in part, on the set of encryption parameters; and transmitting encrypted IP traffic packets to a UPF.

Example 86B may include the method and apparatus of provisioning a group based service in a mobile network for a first network entity (NEF) is to send a first message to a second network entity (UDM) after the first network entity receives a second message indicating for service request from a third network entity (application server), wherein the first message contains at least one of the following information: group service ID, application server ID, service area indicated by service area ID (SAI) or geographical areas, service request type indicated as group, service profile including service time, traffic load, priority, maximum/average/minimum transmission rate, latency, group size (number of devices in the group), DSF request including required data storage capacity, expected access responsive time, data storage ID (DS-ID), and DSF-ID (represented as address/port, FQDN (fully qualified domain name) or an unique identity in the RPLMN (registered PLMN) if obtained but not expired).

Example 87B may include the method of Example 86B or some other Example herein, wherein the second message includes at least one of the following information: group service ID, application server ID, service area indicated by service area ID (SAI) or geographical areas, service request type indicated as group, service profile including service time, traffic load, priority, maximum/average/minimum transmission rate, latency, group size (number of devices in the group), DSF request including required data storage capacity, expected access responsive time, data storage ID (DS-ID), and DSF-ID (represented as address/port, FQDN (fully qualified domain name) or an unique identity in the RPLMN (registered PLMN) if obtained but not expired).

Example 88B may include the method of Example 86B or some other Example herein, wherein the group service area information may be a mapped SAI, or a service area ID (SAI), wherein the mapped SAI is provided by the third network entity or calculated by the first network entity.

Example 89B may include the method of Example 86B or some other Example herein, wherein the first message is sent after receiving a third message from a fourth entity (UDM), wherein the third message indicates at least one of the following information: a temporary group service ID (TGSID), impacted AMF/SMF address information, group service policies according to the service subscription, security parameters for IP packets encryption/integrity protection, subscribed service area information of the group based service which may be a geographical area or a service area ID (SAI), DSF information, valid time for the group service; wherein the group service policies may include the QoS parameters (e.g., MBR, latency requirements), etc.; SAI is maintained via O&M and may be mapped to a SAI (mapped SAI) different from the configured SAI sending from the Application server; the DSF information includes DSF address info (represented as address/port or an FQDN or an unique identity (DSF-ID) in the RPLMN), assigned data storage ID (DS-ID), allowed data storage capacity, valid period.

Example 90B may include the method and apparatus of provisioning a group based service in a mobile network for a first network entity (NEF) is to request for data storage service by sending a first message to a second network entity (DSF), and receiving a second message from the second network entity (DSF); wherein the first message contains at least one of the following information: assigned data storage ID (DS-ID), allowed data storage capacity, valid period, application server ID (address, FQDN); the second message contains at least one of the following information: the successful/failure of the creation of the data storage.

Example 91B may include the method and apparatus of provisioning a group based service in a mobile network for a first network entity (SMF in CN-CPF) is to determine a policy of session management after receiving a first message from a second network entity (NEF), and send a second message to a third network entity (UPF), wherein the second message contains at least one of the following information: the temporary ID, security parameters, routing policies, data storage function address info;

Example 92B may include the method of Example 6B or some other Example herein, wherein the first message contains at least one of the following information: the temporary ID, security parameters, group service area information, policy of session management, and data storage function address info.

Example 93B may include the method of Example 6B or some other Example herein, wherein the security parameter for the third network entity is unique or shared among the CN-CPF controlled domain.

Example 94B may include the method and apparatus of provisioning a group based service in a mobile network for a first network entity (AMF in CN-CPF) is to determine one or more impacted a second network entity (RAN) after receiving a first message from a second network entity (NEF), and send a second message to one or more the second network entity (RAN), wherein the first message contains: the temporary ID, mapped service area identity, QoS parameters, security parameters; the second message contains at least one of the following information: the temporary ID, security parameters, routing policies;

Example 95B may include the method of Example 9B or some other Example herein, wherein the third network entity (RAN) is within the group service area indicated in the first message received from the second network entity.

Example 96B may include the method and apparatus of establishing a first session in a mobile network for a first network entity (SMF in CN-CPF) is to determine if the first network entity uses IP multicast for configuring one or more routing policies for the first session of a group based service, wherein at least one of the following criteria is applied: the IP multicast capability of the network entities, network load conditions.

Example 97B may include the method and apparatus of controlling a first session in a mobile network for a first network entity (SMF in CN-CPF) is to indicate a first message to a second network entity (DGWs in UPF), wherein the first message may include at least one of the following parameters for session control: start, duration, stop, periodic period, session duration.

Example 98B may include the method and apparatus of handling a first session in a mobile network for a first network entity (RAN) is to decrypt the received packets from the first session by using the stored security parameters.

Example 99B may include the method of Example 98B or some other Example herein, wherein the security parameters is received from a second network entity and stored in the group session context.

Example 100B may include the method of Example 98B or some other Example herein, wherein the packets is received from a third network entity (Application server or DSF) which encrypts the content of the IP traffic packets, marks an ID in IP packet header, and starts transmission via an assigned user plane interface.

Example 101B may include the method of Example 100B or some other Example herein, wherein the user plane interface information is preconfigured at the third network entity or obtained from a forth network entity (NEF); wherein the interface information may include the IP address or Port number of a fifth network entity (boundary DGW) which receives the IP packets marked with the temporary ID and enforces the routing rules to duplicates and forwards the IP packets accordingly.

Example 102B may include an apparatus comprising means to perform one or more elements of a method described in or related to any of Examples 1B-101B, or any other method or process described herein.

Example 103B may include one or more non-transitory computer-readable media comprising instructions to cause an electronic device, upon execution of the instructions by one or more processors of the electronic device, to perform one or more elements of a method described in or related to any of Examples 1B-101B, or any other method or process described herein.

Example 104B may include an apparatus comprising logic, modules, or circuitry to perform one or more elements of a method described in or related to any of Examples 1B-101B, or any other method or process described herein.

Example 105B may include a method, technique, or process as described in or related to any of Examples 1B-101B, or portions or parts thereof.

Example 106B may include an apparatus comprising: one or more processors and one or more computer readable media comprising instructions that, when executed by the one or more processors, cause the one or more processors to perform the method, techniques, or process as described in or related to any of Examples 1B-101B, or portions thereof.

Example 107B may include a method of communicating in a wireless network as shown and described herein.

Example 108B may include a system for providing wireless communication as shown and described herein.

Example 109B may include a device for providing wireless communication as shown and described herein.

### C. Example Systems and Methods

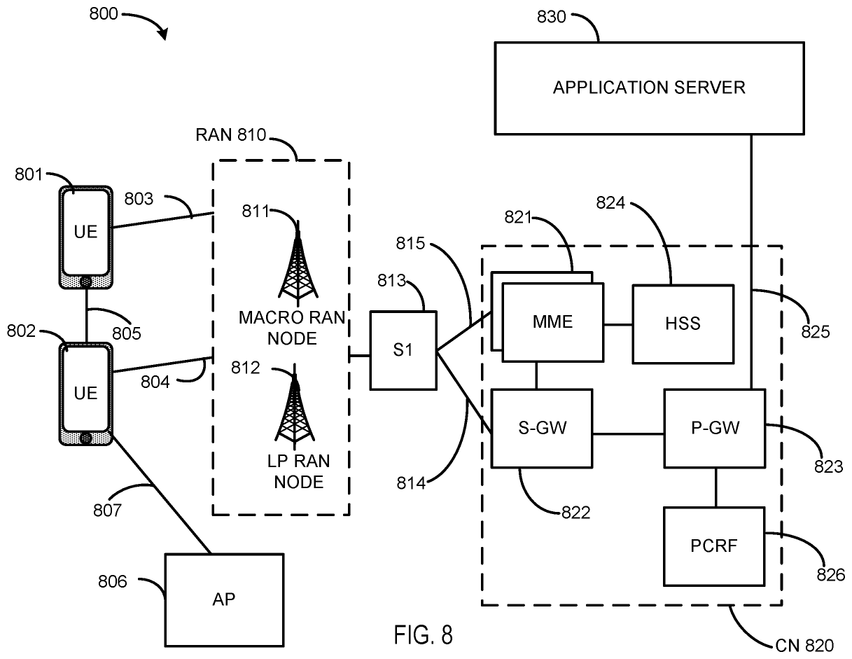

FIG. 8 illustrates an architecture of a system 800 of a network in accordance with some embodiments. The system 800 is shown to include a user equipment (UE) 801 and a UE 802. The UEs 801 and 802 are illustrated as smartphones (e.g., handheld touchscreen mobile computing devices connectable to one or more cellular networks), but may also comprise any mobile or non-mobile computing device, such as Personal Data Assistants (PDAs), pagers, laptop computers, desktop computers, wireless handsets, or any computing device including a wireless communications interface.

In some embodiments, any of the UEs 801 and 802 can comprise an Internet of Things (IoT) UE, which can comprise a network access layer designed for low-power IoT applications utilizing short-lived UE connections. An IoT UE can utilize technologies such as machine-to-machine (M2M) or machine-type communications (MTC) for exchanging data with an MTC server or device via a public land mobile network (PLMN), Proximity-Based Service (ProSe) or device-to-device (D2D) communication, sensor networks, or IoT networks. The M2M or MTC exchange of data may be a machine-initiated exchange of data. An IoT network describes interconnecting IoT UEs, which may include uniquely identifiable embedded computing devices (within the Internet infrastructure), with short-lived connections. The IoT UEs may execute background applications (e.g., keep-alive messages, status updates, etc.) to facilitate the connections of the IoT network.

The UEs 801 and 802 may be configured to connect, e.g., communicatively couple, with a radio access network (RAN) 810. The RAN 810 may be, for example, an Evolved Universal Mobile Telecommunications System (UMTS) Terrestrial Radio Access Network (E-UTRAN), a NextGen RAN (NG RAN), or some other type of RAN. The UEs 801 and 802 utilize connections 803 and 804, respectively, each of which comprises a physical communications interface or layer (discussed in further detail below); in this example, the connections 803 and 804 are illustrated as an air interface to enable communicative coupling, and can be consistent with cellular communications protocols, such as a Global System for Mobile Communications (GSM) protocol, a code-division multiple access (CDMA) network protocol, a Push-to-Talk (PTT) protocol, a PTT over Cellular (POC) protocol, a Universal Mobile Telecommunications System (UMTS) protocol, a 3GPP Long Term Evolution (LTE) protocol, a fifth generation (5G) protocol, a New Radio (NR) protocol, and the like.

In this embodiment, the UEs 801 and 802 may further directly exchange communication data via a ProSe interface 805. The ProSe interface 805 may alternatively be referred to as a sidelink interface comprising one or more logical channels, including but not limited to a Physical Sidelink Control Channel (PSCCH), a Physical Sidelink Shared Channel (PSSCH), a Physical Sidelink Discovery Channel (PSDCH), and a Physical Sidelink Broadcast Channel (PSBCH).

The UE 802 is shown to be configured to access an access point (AP) 806 via connection 807. The connection 807 can comprise a local wireless connection, such as a connection consistent with any IEEE 802.11 protocol, wherein the AP 806 would comprise a wireless fidelity (WiFi®) router. In this example, the AP 806 may be connected to the Internet without connecting to the core network of the wireless system (described in further detail below).

The RAN 810 can include one or more access nodes that enable the connections 803 and 804. These access nodes (ANs) can be referred to as base stations (BSs), NodeBs, evolved NodeBs (eNBs), next Generation NodeBs (gNB), RAN nodes, and so forth, and can comprise ground stations (e.g., terrestrial access points) or satellite stations providing coverage within a geographic area (e.g., a cell). The RAN 810 may include one or more RAN nodes for providing macrocells, e.g., macro RAN node 811, and one or more RAN nodes for providing femtocells or picocells (e.g., cells having smaller coverage areas, smaller user capacity, or higher bandwidth compared to macrocells), e.g., low power (LP) RAN node 812.

Any of the RAN nodes 811 and 812 can terminate the air interface protocol and can be the first point of contact for the UEs 801 and 802. In some embodiments, any of the RAN nodes 811 and 812 can fulfill various logical functions for the RAN 810 including, but not limited to, radio network controller (RNC) functions such as radio bearer management, uplink and downlink dynamic radio resource management and data packet scheduling, and mobility management.

In accordance with some embodiments, the UEs 801 and 802 can be configured to communicate using Orthogonal Frequency-Division Multiplexing (OFDM) communication signals with each other or with any of the RAN nodes 811 and 812 over a multicarrier communication channel in accordance various communication techniques, such as, but not limited to, an Orthogonal Frequency-Division Multiple Access (OFDMA) communication technique (e.g., for downlink communications) or a Single Carrier Frequency Division Multiple Access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, a downlink resource grid can be used for downlink transmissions from any of the RAN nodes 811 and 812 to the UEs 801 and 802, while uplink transmissions can utilize similar techniques. The grid can be a time-frequency grid, called a resource grid or time-frequency resource grid, which is the physical resource in the downlink in each slot. Such a time-frequency plane representation is a common practice for OFDM systems, which makes it intuitive for radio resource allocation. Each column and each row of the resource grid corresponds to one OFDM symbol and one OFDM subcarrier, respectively. The duration of the resource grid in the time domain corresponds to one slot in a radio frame. The smallest time-frequency unit in a resource grid is denoted as a resource element. Each resource grid comprises a number of resource blocks, which describe the mapping of certain physical channels to resource elements. Each resource block comprises a collection of resource elements; in the frequency domain, this may represent the smallest quantity of resources that currently can be allocated. There are several different physical downlink channels that are conveyed using such resource blocks.

The physical downlink shared channel (PDSCH) may carry user data and higher-layer signaling to the UEs 801 and 802. The physical downlink control channel (PDCCH) may carry information about the transport format and resource allocations related to the PDSCH channel, among other things. It may also inform the UEs 801 and 802 about the transport format, resource allocation, and H-ARQ (Hybrid Automatic Repeat Request) information related to the uplink shared channel. Typically, downlink scheduling (assigning control and shared channel resource blocks to the UE 802 within a cell) may be performed at any of the RAN nodes 811 and 812 based on channel quality information fed back from any of the UEs 801 and 802. The downlink resource assignment information may be sent on the PDCCH used for (e.g., assigned to) each of the UEs 801 and 802.

The PDCCH may use control channel elements (CCEs) to convey the control information. Before being mapped to resource elements, the PDCCH complex-valued symbols may first be organized into quadruplets, which may then be permuted using a sub-block interleaver for rate matching. Each PDCCH may be transmitted using one or more of these CCEs, where each CCE may correspond to nine sets of four physical resource elements known as resource element groups (REGs). Four Quadrature Phase Shift Keying (QPSK) symbols may be mapped to each REG. The PDCCH can be transmitted using one or more CCEs, depending on the size of the downlink control information (DCI) and the channel condition. There can be four or more different PDCCH formats defined in LTE with different numbers of CCEs (e.g., aggregation level, L=1, 2, 4, or 8).

Some embodiments may use concepts for resource allocation for control channel information that are an extension of the above-described concepts. For example, some embodiments may utilize an enhanced physical downlink control channel (EPDCCH) that uses PDSCH resources for control information transmission. The EPDCCH may be transmitted using one or more enhanced the control channel elements (ECCEs). Similar to above, each ECCE may correspond to nine sets of four physical resource elements known as enhanced resource element groups (EREGs). An ECCE may have other numbers of EREGs in some situations.

The RAN 810 is shown to be communicatively coupled to a core network (CN) 820—via an S1 interface 813. In embodiments, the CN 820 may be an evolved packet core (EPC) network, a NextGen Packet Core (NPC) network, or some other type of CN. In this embodiment the S1 interface 813 is split into two parts: the S1-U interface 814, which carries traffic data between the RAN nodes 811 and 812 and a serving gateway (S-GW) 822, and an S1-mobility management entity (MME) interface 815, which is a signaling interface between the RAN nodes 811 and 812 and MMEs 821.

In this embodiment, the CN 820 comprises the MMEs 821, the S-GW 822, a Packet Data Network (PDN) Gateway (P-GW) 823, and a home subscriber server (HSS) 824. The MMEs 821 may be similar in function to the control plane of legacy Serving General Packet Radio Service (GPRS) Support Nodes (SGSN). The MMEs 821 may manage mobility aspects in access such as gateway selection and tracking area list management. The HSS 824 may comprise a database for network users, including subscription-related information to support the network entities' handling of communication sessions. The CN 820 may comprise one or several HSSs 824, depending on the number of mobile subscribers, on the capacity of the equipment, on the organization of the network, etc. For example, the HSS 824 can provide support for routing/roaming, authentication, authorization, naming/addressing resolution, location dependencies, etc.

The S-GW 822 may terminate the S1 interface 813 towards the RAN 810, and routes data packets between the RAN 810 and the CN 820. In addition, the S-GW 822 may be a local mobility anchor point for inter-RAN node handovers and also may provide an anchor for inter-3GPP mobility. Other responsibilities may include lawful intercept, charging, and some policy enforcement.

The P-GW 823 may terminate an SGi interface toward a PDN. The P-GW 823 may route data packets between the CN 820 (e.g., an EPC network) and external networks such as a network including the application server 830 (alternatively referred to as application function (AF)) via an Internet Protocol (IP) interface 825. Generally, an application server 830 may be an element offering applications that use IP bearer resources with the core network (e.g., UMTS Packet Services (PS) domain, LTE PS data services, etc.). In this embodiment, the P-GW 823 is shown to be communicatively coupled to an application server 830 via an IP communications interface 825. The application server 830 can also be configured to support one or more communication services (e.g., Voice-over-Internet Protocol (VoIP) sessions, PTT sessions, group communication sessions, social networking services, etc.) for the UEs 801 and 802 via the CN 820.

The P-GW 823 may further be a node for policy enforcement and charging data collection. A Policy and Charging Enforcement Function (PCRF) 826 is the policy and charging control element of the CN 820. In a non-roaming scenario, there may be a single PCRF in the Home Public Land Mobile Network (HPLMN) associated with a UE's Internet Protocol Connectivity Access Network (IP-CAN) session. In a roaming scenario with local breakout of traffic, there may be two PCRFs associated with a UE's IP-CAN session: a Home PCRF (H-PCRF) within a HPLMN and a Visited PCRF (V-PCRF) within a Visited Public Land Mobile Network (VPLMN). The PCRF 826 may be communicatively coupled to the application server 830 via the P-GW 823. The application server 830 may signal the PCRF 826 to indicate a new service flow and select the appropriate Quality of Service (QoS) and charging parameters. The PCRF 826 may provision this rule into a Policy and Charging Enforcement Function (PCEF) (not shown) with the appropriate traffic flow template (TFT) and QoS class of identifier (QCI), which commences the QoS and charging as specified by the application server 830.

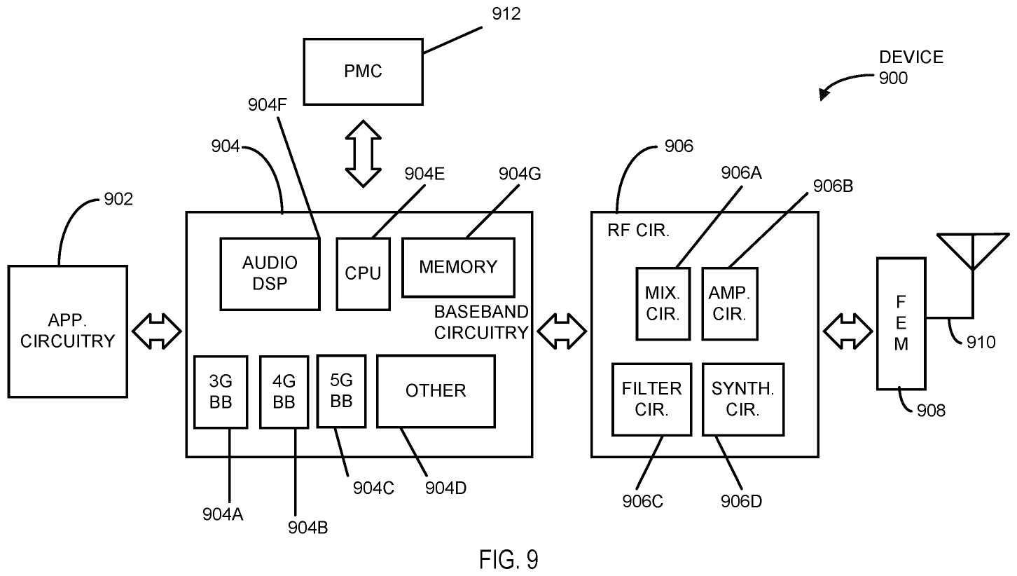

FIG. 9 illustrates example components of a device 900 in accordance with some embodiments. In some embodiments, the device 900 may include application circuitry 902, baseband circuitry 904, Radio Frequency (RF) circuitry 906, front-end module (FEM) circuitry 908, one or more antennas 910, and power management circuitry (PMC) 912 coupled together at least as shown. The components of the illustrated device 900 may be included in a UE or a RAN node. In some embodiments, the device 900 may include fewer elements (e.g., a RAN node may not utilize application circuitry 902, and instead include a processor/controller to process IP data received from an EPC). In some embodiments, the device 900 may include additional elements such as, for example, memory/storage, display, camera, sensor, or input/output (I/O) interface. In other embodiments, the components described below may be included in more than one device (e.g., said circuitries may be separately included in more than one device for Cloud-RAN (C-RAN) implementations).

The application circuitry 902 may include one or more application processors. For example, the application circuitry 902 may include circuitry such as, but not limited to, one or more single-core or multi-core processors. The processor(s) may include any combination of general-purpose processors and dedicated processors (e.g., graphics processors, application processors, etc.). The processors may be coupled with or may include memory/storage and may be configured to execute instructions stored in the memory/storage to enable various applications or operating systems to run on the device 900. In some embodiments, processors of application circuitry 902 may process IP data packets received from an EPC.

The baseband circuitry 904 may include circuitry such as, but not limited to, one or more single-core or multi-core processors. The baseband circuitry 904 may include one or more baseband processors or control logic to process baseband signals received from a receive signal path of the RF circuitry 906 and to generate baseband signals for a transmit signal path of the RF circuitry 906. Baseband processing circuitry 904 may interface with the application circuitry 902 for generation and processing of the baseband signals and for controlling operations of the RF circuitry 906. For example, in some embodiments, the baseband circuitry 904 may include a third generation (3G) baseband processor 904A, a fourth generation (4G) baseband processor 904B, a fifth generation (5G) baseband processor 904C, or other baseband processor(s) 904D for other existing generations, generations in development or to be developed in the future (e.g., second generation (2G), sixth generation (6G), etc.). The baseband circuitry 904 (e.g., one or more of baseband processors 904A-D) may handle various radio control functions that enable communication with one or more radio networks via the RF circuitry 906. In other embodiments, some or all of the functionality of baseband processors 904A-D may be included in modules stored in the memory 904G and executed via a Central Processing Unit (CPU) 904E. The radio control functions may include, but are not limited to, signal modulation/demodulation, encoding/decoding, radio frequency shifting, etc. In some embodiments, modulation/demodulation circuitry of the baseband circuitry 904 may include Fast-Fourier Transform (FFT), precoding, or constellation mapping/demapping functionality. In some embodiments, encoding/decoding circuitry of the baseband circuitry 904 may include convolution, tail-biting convolution, turbo, Viterbi, or Low Density Parity Check (LDPC) encoder/decoder functionality. Embodiments of modulation/demodulation and encoder/decoder functionality are not limited to these examples and may include other suitable functionality in other embodiments.

In some embodiments, the baseband circuitry 904 may include one or more audio digital signal processor(s) (DSP) 904F. The audio DSP(s) 904F may be include elements for compression/decompression and echo cancellation and may include other suitable processing elements in other embodiments. Components of the baseband circuitry may be suitably combined in a single chip, a single chipset, or disposed on a same circuit board in some embodiments. In some embodiments, some or all of the constituent components of the baseband circuitry 904 and the application circuitry 902 may be implemented together such as, for example, on a system on a chip (SOC).

In some embodiments, the baseband circuitry 904 may provide for communication compatible with one or more radio technologies. For example, in some embodiments, the baseband circuitry 904 may support communication with an evolved universal terrestrial radio access network (EUTRAN) or other wireless metropolitan area networks (WMAN), a wireless local area network (WLAN), or a wireless personal area network (WPAN). Embodiments in which the baseband circuitry 904 is configured to support radio communications of more than one wireless protocol may be referred to as multi-mode baseband circuitry.

RF circuitry 906 may enable communication with wireless networks using modulated electromagnetic radiation through a non-solid medium. In various embodiments, the RF circuitry 906 may include switches, filters, amplifiers, etc. to facilitate the communication with the wireless network. The RF circuitry 906 may include a receive signal path which may include circuitry to down-convert RF signals received from the FEM circuitry 908 and provide baseband signals to the baseband circuitry 904. RF circuitry 906 may also include a transmit signal path which may include circuitry to up-convert baseband signals provided by the baseband circuitry 904 and provide RF output signals to the FEM circuitry 908 for transmission.

In some embodiments, the receive signal path of the RF circuitry 906 may include mixer circuitry 906A, amplifier circuitry 906B and filter circuitry 906C. In some embodiments, the transmit signal path of the RF circuitry 906 may include filter circuitry 906C and mixer circuitry 906A. RF circuitry 906 may also include synthesizer circuitry 906D for synthesizing a frequency for use by the mixer circuitry 906A of the receive signal path and the transmit signal path. In some embodiments, the mixer circuitry 906A of the receive signal path may be configured to down-convert RF signals received from the FEM circuitry 908 based on the synthesized frequency provided by synthesizer circuitry 906D. The amplifier circuitry 906B may be configured to amplify the down-converted signals and the filter circuitry 906C may be a low-pass filter (LPF) or band-pass filter (BPF) configured to remove unwanted signals from the down-converted signals to generate output baseband signals. Output baseband signals may be provided to the baseband circuitry 904 for further processing. In some embodiments, the output baseband signals may be zero-frequency baseband signals, although this is not a requirement. In some embodiments, the mixer circuitry 906A of the receive signal path may comprise passive mixers, although the scope of the embodiments is not limited in this respect.

In some embodiments, the mixer circuitry 906A of the transmit signal path may be configured to up-convert input baseband signals based on the synthesized frequency provided by the synthesizer circuitry 906D to generate RF output signals for the FEM circuitry 908. The baseband signals may be provided by the baseband circuitry 904 and may be filtered by the filter circuitry 906C.

In some embodiments, the mixer circuitry 906A of the receive signal path and the mixer circuitry 906A of the transmit signal path may include two or more mixers and may be arranged for quadrature downconversion and upconversion, respectively. In some embodiments, the mixer circuitry 906A of the receive signal path and the mixer circuitry 906A of the transmit signal path may include two or more mixers and may be arranged for image rejection (e.g., Hartley image rejection). In some embodiments, the mixer circuitry 906A of the receive signal path and the mixer circuitry 906A may be arranged for direct downconversion and direct upconversion, respectively. In some embodiments, the mixer circuitry 906A of the receive signal path and the mixer circuitry 906A of the transmit signal path may be configured for super-heterodyne operation.

In some embodiments, the output baseband signals and the input baseband signals may be analog baseband signals, although the scope of the embodiments is not limited in this respect. In some alternate embodiments, the output baseband signals and the input baseband signals may be digital baseband signals. In these alternate embodiments, the RF circuitry 906 may include analog-to-digital converter (ADC) and digital-to-analog converter (DAC) circuitry and the baseband circuitry 904 may include a digital baseband interface to communicate with the RF circuitry 906.

In some dual-mode embodiments, a separate radio IC circuitry may be provided for processing signals for each spectrum, although the scope of the embodiments is not limited in this respect.

In some embodiments, the synthesizer circuitry 906D may be a fractional-N synthesizer or a fractional N/N+1 synthesizer, although the scope of the embodiments is not limited in this respect as other types of frequency synthesizers may be suitable. For example, synthesizer circuitry 906D may be a delta-sigma synthesizer, a frequency multiplier, or a synthesizer comprising a phase-locked loop with a frequency divider.

The synthesizer circuitry 906D may be configured to synthesize an output frequency for use by the mixer circuitry 906A of the RF circuitry 906 based on a frequency input and a divider control input. In some embodiments, the synthesizer circuitry 906D may be a fractional N/N+1 synthesizer.

In some embodiments, frequency input may be provided by a voltage controlled oscillator (VCO), although that is not a requirement. Divider control input may be provided by either the baseband circuitry 904 or the application circuitry 902 (such as an applications processor) depending on the desired output frequency. In some embodiments, a divider control input (e.g., N) may be determined from a look-up table based on a channel indicated by the application circuitry 902.

Synthesizer circuitry 906D of the RF circuitry 906 may include a divider, a delay-locked loop (DLL), a multiplexer and a phase accumulator. In some embodiments, the divider may be a dual modulus divider (DMD) and the phase accumulator may be a digital phase accumulator (DPA). In some embodiments, the DMD may be configured to divide the input signal by either N or N+1 (e.g., based on a carry out) to provide a fractional division ratio. In some example embodiments, the DLL may include a set of cascaded, tunable, delay elements, a phase detector, a charge pump and a D-type flip-flop. In these embodiments, the delay elements may be configured to break a VCO period up into Nd equal packets of phase, where Nd is the number of delay elements in the delay line. In this way, the DLL provides negative feedback to help ensure that the total delay through the delay line is one VCO cycle.

In some embodiments, the synthesizer circuitry 906D may be configured to generate a carrier frequency as the output frequency, while in other embodiments, the output frequency may be a multiple of the carrier frequency (e.g., twice the carrier frequency, four times the carrier frequency) and used in conjunction with quadrature generator and divider circuitry to generate multiple signals at the carrier frequency with multiple different phases with respect to each other. In some embodiments, the output frequency may be a LO frequency (fLO). In some embodiments, the RF circuitry 906 may include an IQ/polar converter.

FEM circuitry 908 may include a receive signal path which may include circuitry configured to operate on RF signals received from one or more antennas 910, amplify the received signals and provide the amplified versions of the received signals to the RF circuitry 906 for further processing. The FEM circuitry 908 may also include a transmit signal path which may include circuitry configured to amplify signals for transmission provided by the RF circuitry 906 for transmission by one or more of the one or more antennas 910. In various embodiments, the amplification through the transmit or receive signal paths may be done solely in the RF circuitry 906, solely in the FEM circuitry 908, or in both the RF circuitry 906 and the FEM circuitry 908.

In some embodiments, the FEM circuitry 908 may include a TX/RX switch to switch between transmit mode and receive mode operation. The FEM circuitry 908 may include a receive signal path and a transmit signal path. The receive signal path of the FEM circuitry 908 may include an LNA to amplify received RF signals and provide the amplified received RF signals as an output (e.g., to the RF circuitry 906). The transmit signal path of the FEM circuitry 908 may include a power amplifier (PA) to amplify input RF signals (e.g., provided by the RF circuitry 906), and one or more filters to generate RF signals for subsequent transmission (e.g., by one or more of the one or more antennas 910).

In some embodiments, the PMC 912 may manage power provided to the baseband circuitry 904. In particular, the PMC 912 may control power-source selection, voltage scaling, battery charging, or DC-to-DC conversion. The PMC 912 may often be included when the device 900 is capable of being powered by a battery, for example, when the device 900 is included in a UE. The PMC 912 may increase the power conversion efficiency while providing desirable implementation size and heat dissipation characteristics.

FIG. 9 shows the PMC 912 coupled only with the baseband circuitry 904. However, in other embodiments, the PMC 912 may be additionally or alternatively coupled with, and perform similar power management operations for, other components such as, but not limited to, the application circuitry 902, the RF circuitry 906, or the FEM circuitry 908.

In some embodiments, the PMC 912 may control, or otherwise be part of, various power saving mechanisms of the device 900. For example, if the device 900 is in an RRC_Connected state, where it is still connected to the RAN node as it expects to receive traffic shortly, then it may enter a state known as Discontinuous Reception Mode (DRX) after a period of inactivity. During this state, the device 900 may power down for brief intervals of time and thus save power.

If there is no data traffic activity for an extended period of time, then the device 900 may transition off to an RRC_Idle state, where it disconnects from the network and does not perform operations such as channel quality feedback, handover, etc. The device 900 goes into a very low power state and it performs paging where again it periodically wakes up to listen to the network and then powers down again. The device 900 may not receive data in this state, and in order to receive data, it transitions back to an RRC_Connected state.

An additional power saving mode may allow a device to be unavailable to the network for periods longer than a paging interval (ranging from seconds to a few hours). During this time, the device is totally unreachable to the network and may power down completely. Any data sent during this time incurs a large delay and it is assumed the delay is acceptable.

Processors of the application circuitry 902 and processors of the baseband circuitry 904 may be used to execute elements of one or more instances of a protocol stack. For example, processors of the baseband circuitry 904, alone or in combination, may be used to execute Layer 3, Layer 2, or Layer 1 functionality, while processors of the application circuitry 902 may utilize data (e.g., packet data) received from these layers and further execute Layer 4 functionality (e.g., transmission communication protocol (TCP) and user datagram protocol (UDP) layers). As referred to herein, Layer 3 may comprise a radio resource control (RRC) layer, described in further detail below. As referred to herein, Layer 2 may comprise a medium access control (MAC) layer, a radio link control (RLC) layer, and a packet data convergence protocol (PDCP) layer, described in further detail below. As referred to herein, Layer 1 may comprise a physical (PHY) layer of a UE/RAN node, described in further detail below.

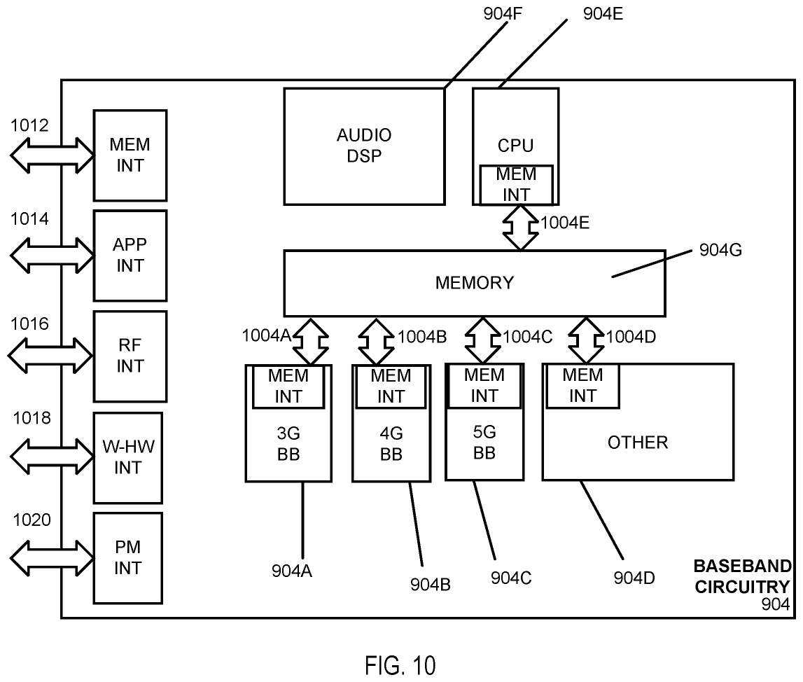

FIG. 10 illustrates example interfaces of baseband circuitry in accordance with some embodiments. As discussed above, the baseband circuitry 904 of FIG. 9 may comprise processors 904A-904E and a memory 904G utilized by said processors. Each of the processors 904A-904E may include a memory interface, 1004A-1004E, respectively, to send/receive data to/from the memory 904G.

The baseband circuitry 904 may further include one or more interfaces to communicatively couple to other circuitries/devices, such as a memory interface 1012 (e.g., an interface to send/receive data to/from memory external to the baseband circuitry 904), an application circuitry interface 1014 (e.g., an interface to send/receive data to/from the application circuitry 902 of FIG. 9), an RF circuitry interface 1016 (e.g., an interface to send/receive data to/from RF circuitry 906 of FIG. 9), a wireless hardware connectivity interface 1018 (e.g., an interface to send/receive data to/from Near Field Communication (NFC) components, Bluetooth® components (e.g., Bluetooth® Low Energy), Wi-Fi® components, and other communication components), and a power management interface 1020 (e.g., an interface to send/receive power or control signals to/from the PMC 912.

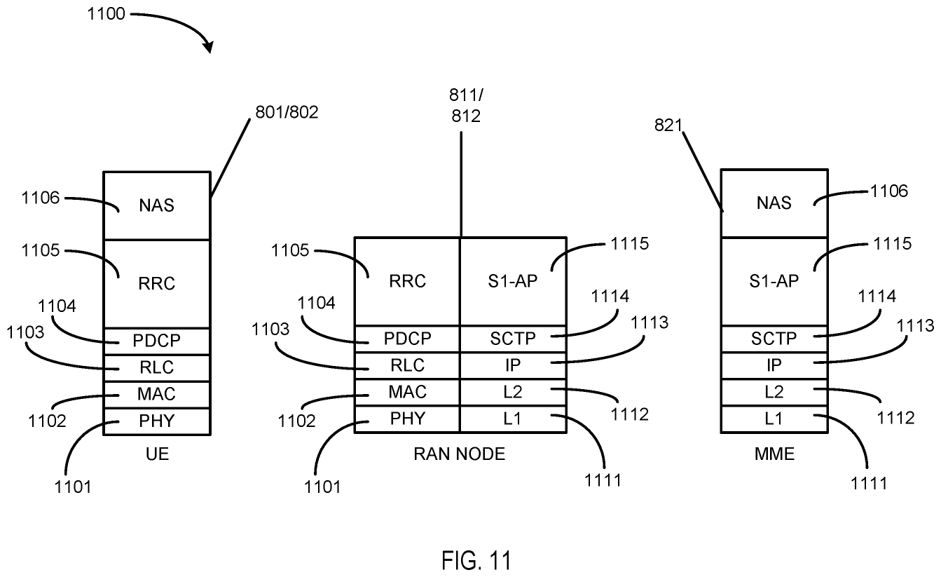

FIG. 11 is an illustration of a control plane protocol stack in accordance with some embodiments. In this embodiment, a control plane 1100 is shown as a communications protocol stack between the UE 801 (or alternatively, the UE 802), the RAN node 811 (or alternatively, the RAN node 812), and the MME 821.

A PHY layer 1101 may transmit or receive information used by the MAC layer 1102 over one or more air interfaces. The PHY layer 1101 may further perform link adaptation or adaptive modulation and coding (AMC), power control, cell search (e.g., for initial synchronization and handover purposes), and other measurements used by higher layers, such as an RRC layer 1105. The PHY layer 1101 may still further perform error detection on the transport channels, forward error correction (FEC) coding/decoding of the transport channels, modulation/demodulation of physical channels, interleaving, rate matching, mapping onto physical channels, and Multiple Input Multiple Output (MIMO) antenna processing.

The MAC layer 1102 may perform mapping between logical channels and transport channels, multiplexing of MAC service data units (SDUs) from one or more logical channels onto transport blocks (TB) to be delivered to PHY via transport channels, de-multiplexing MAC SDUs to one or more logical channels from transport blocks (TB) delivered from the PHY via transport channels, multiplexing MAC SDUs onto TBs, scheduling information reporting, error correction through hybrid automatic repeat request (HARQ), and logical channel prioritization.

An RLC layer 1103 may operate in a plurality of modes of operation, including: Transparent Mode (TM), Unacknowledged Mode (UM), and Acknowledged Mode (AM). The RLC layer 1103 may execute transfer of upper layer protocol data units (PDUs), error correction through automatic repeat request (ARQ) for AM data transfers, and concatenation, segmentation and reassembly of RLC SDUs for UM and AM data transfers. The RLC layer 1103 may also execute re-segmentation of RLC data PDUs for AM data transfers, reorder RLC data PDUs for UM and AM data transfers, detect duplicate data for UM and AM data transfers, discard RLC SDUs for UM and AM data transfers, detect protocol errors for AM data transfers, and perform RLC re-establishment.

A PDCP layer 1104 may execute header compression and decompression of IP data, maintain PDCP Sequence Numbers (SNs), perform in-sequence delivery of upper layer PDUs at re-establishment of lower layers, eliminate duplicates of lower layer SDUs at re-establishment of lower layers for radio bearers mapped on RLC AM, cipher and decipher control plane data, perform integrity protection and integrity verification of control plane data, control timer-based discard of data, and perform security operations (e.g., ciphering, deciphering, integrity protection, integrity verification, etc.).

The main services and functions of the RRC layer 1105 may include broadcast of system information (e.g., included in Master Information Blocks (MIBs) or System Information Blocks (SIBs) related to the non-access stratum (NAS)), broadcast of system information related to the access stratum (AS), paging, establishment, maintenance and release of an RRC connection between the UE and E-UTRAN (e.g., RRC connection paging, RRC connection establishment, RRC connection modification, and RRC connection release), establishment, configuration, maintenance and release of point-to-point radio bearers, security functions including key management, inter radio access technology (RAT) mobility, and measurement configuration for UE measurement reporting. Said MIBs and SIBs may comprise one or more information elements (lEs), which may each comprise individual data fields or data structures.

The UE 801 and the RAN node 811 may utilize a Uu interface (e.g., an LTE-Uu interface) to exchange control plane data via a protocol stack comprising the PHY layer 1101, the MAC layer 1102, the RLC layer 1103, the PDCP layer 1104, and the RRC layer 1105.

In the embodiment shown, the non-access stratum (NAS) protocols 1106 form the highest stratum of the control plane between the UE 801 and the MME 821. The NAS protocols 1106 support the mobility of the UE 801 and the session management procedures to establish and maintain IP connectivity between the UE 801 and the P-GW 823.

The S1 Application Protocol (S1-AP) layer 1115 may support the functions of the S1 interface and comprise Elementary Procedures (EPs). An EP is a unit of interaction between the RAN node 811 and the CN 820. The S1-AP layer services may comprise two groups: UE-associated services and non UE-associated services. These services perform functions including, but not limited to: E-UTRAN Radio Access Bearer (E-RAB) management, UE capability indication, mobility, NAS signaling transport, RAN Information Management (RIM), and configuration transfer.

The Stream Control Transmission Protocol (SCTP) layer (alternatively referred to as the stream control transmission protocol/internet protocol (SCTP/IP) layer) 1114 may ensure reliable delivery of signaling messages between the RAN node 811 and the MME 821 based, in part, on the IP protocol, supported by an IP layer 1113. An L2 layer 1112 and an L1 layer 1111 may refer to communication links (e.g., wired or wireless) used by the RAN node and the MME to exchange information.

The RAN node 811 and the MME 821 may utilize an S1-MME interface to exchange control plane data via a protocol stack comprising the L1 layer 1111, the L2 layer 1112, the IP layer 1113, the SCTP layer 1114, and the S1-AP layer 1115.

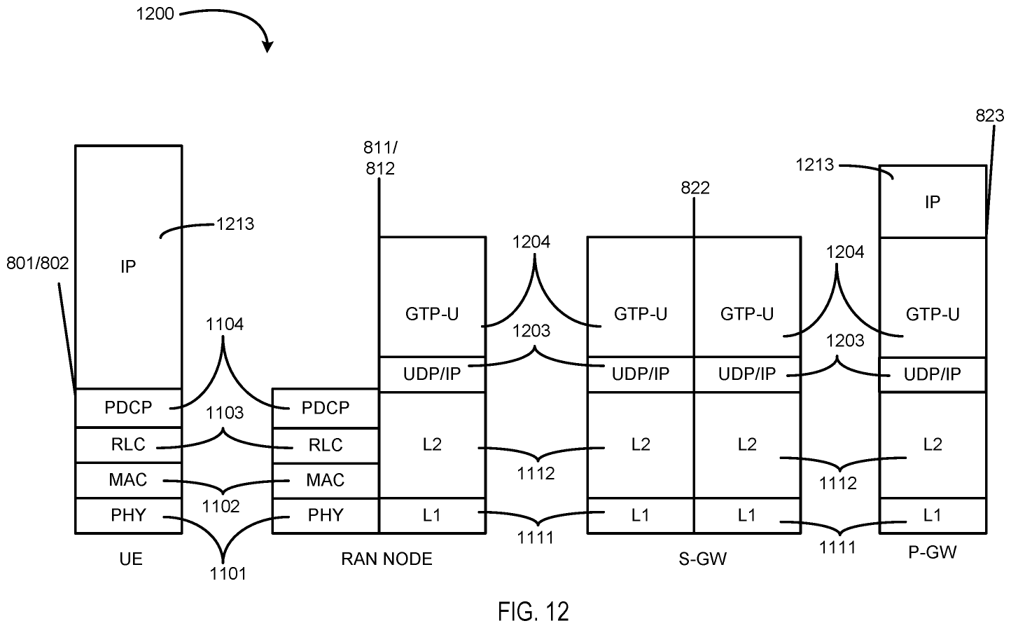

FIG. 12 is an illustration of a user plane protocol stack in accordance with some embodiments. In this embodiment, a user plane 1200 is shown as a communications protocol stack between the UE 801 (or alternatively, the UE 802), the RAN node 811 (or alternatively, the RAN node 812), the S-GW 822, and the P-GW 823. The user plane 1200 may utilize at least some of the same protocol layers as the control plane 1100. For example, the UE 801 and the RAN node 811 may utilize a Uu interface (e.g., an LTE-Uu interface) to exchange user plane data via a protocol stack comprising the PHY layer 1101, the MAC layer 1102, the RLC layer 1103, the PDCP layer 1104.

The General Packet Radio Service (GPRS) Tunneling Protocol for the user plane (GTP-U) layer 1204 may be used for carrying user data within the GPRS core network and between the radio access network and the core network. The user data transported can be packets in any of IPv4, IPv6, or PPP formats, for example. The UDP and IP security (UDP/IP) layer 1203 may provide checksums for data integrity, port numbers for addressing different functions at the source and destination, and encryption and authentication on the selected data flows. The RAN node 811 and the S-GW 822 may utilize an S1-U interface to exchange user plane data via a protocol stack comprising the L1 layer 1111, the L2 layer 1112, the UDP/IP layer 1203, and the GTP—U layer 1204. The S-GW 822 and the P-GW 823 may utilize an S5/S8a interface to exchange user plane data via a protocol stack comprising the L1 layer 1111, the L2 layer 1112, the UDP/IP layer 1203, and the GTP—U layer 1204. As discussed above with respect to FIG. 11, NAS protocols support the mobility of the UE 801 and the session management procedures to establish and maintain IP connectivity between the UE 801 and the P-GW 823.

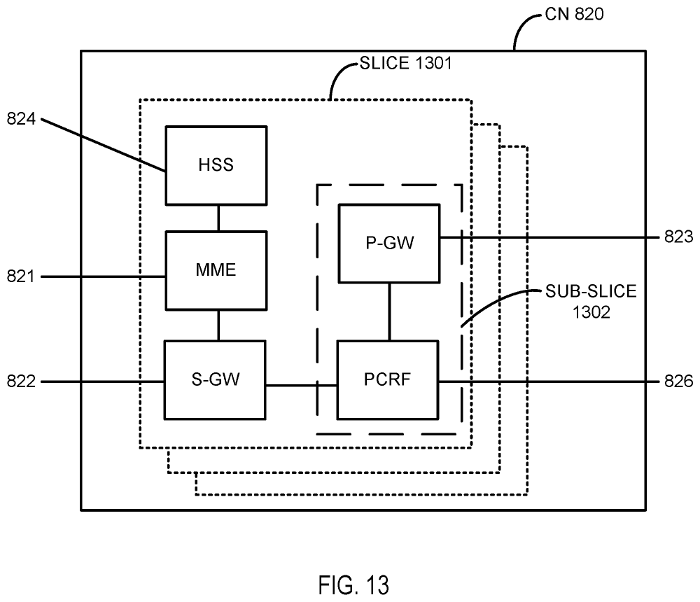

FIG. 13 illustrates components of a core network in accordance with some embodiments. The components of the CN 820 may be implemented in one physical node or separate physical nodes including components to read and execute instructions from a machine-readable or computer-readable medium (e.g., a non-transitory machine-readable storage medium). In some embodiments, Network Functions Virtualization (NFV) is utilized to virtualize any or all of the above described network node functions via executable instructions stored in one or more computer readable storage mediums (described in further detail below). A logical instantiation of the CN 820 may be referred to as a network slice 1301. A logical instantiation of a portion of the CN 820 may be referred to as a network sub-slice 1302 (e.g., the network sub-slice 1302 is shown to include the PGW 823 and the PCRF 826).

NFV architectures and infrastructures may be used to virtualize one or more network functions, alternatively performed by proprietary hardware, onto physical resources comprising a combination of industry-standard server hardware, storage hardware, or switches. In other words, NFV systems can be used to execute virtual or reconfigurable implementations of one or more EPC components/functions.

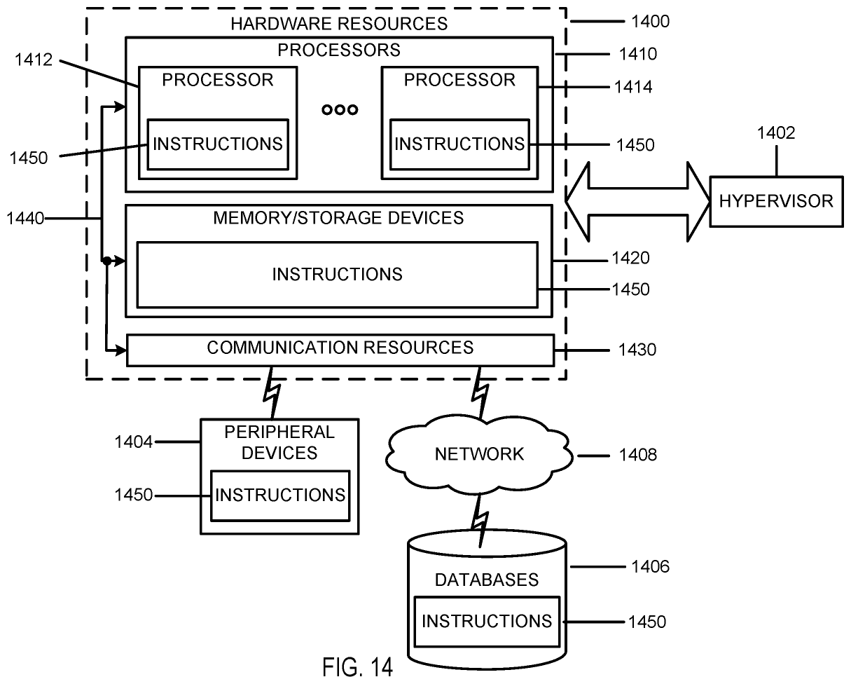

FIG. 14 is a block diagram illustrating components, according to some example embodiments, able to read instructions from a machine-readable or computer-readable medium (e.g., a non-transitory machine-readable storage medium) and perform any one or more of the methodologies discussed herein. Specifically, FIG. 14 shows a diagrammatic representation of hardware resources 1400 including one or more processors (or processor cores) 1410, one or more memory/storage devices 1420, and one or more communication resources 1430, each of which may be communicatively coupled via a bus 1440. For embodiments where node virtualization (e.g., NFV) is utilized, a hypervisor 1402 may be executed to provide an execution environment for one or more network slices/sub-slices to utilize the hardware resources 1400.

The processors 1410 (e.g., a central processing unit (CPU), a reduced instruction set computing (RISC) processor, a complex instruction set computing (CISC) processor, a graphics processing unit (GPU), a digital signal processor (DSP) such as a baseband processor, an application specific integrated circuit (ASIC), a radio-frequency integrated circuit (RFIC), another processor, or any suitable combination thereof) may include, for example, a processor 1412 and a processor 1414.

The memory/storage devices 1420 may include main memory, disk storage, or any suitable combination thereof. The memory/storage devices 1420 may include, but are not limited to any type of volatile or non-volatile memory such as dynamic random access memory (DRAM), static random-access memory (SRAM), erasable programmable read-only memory (EPROM), electrically erasable programmable read-only memory (EEPROM), Flash memory, solid-state storage, etc.

The communication resources 1430 may include interconnection or network interface components or other suitable devices to communicate with one or more peripheral devices 1404 or one or more databases 1406 via a network 1408. For example, the communication resources 1430 may include wired communication components (e.g., for coupling via a Universal Serial Bus (USB)), cellular communication components, NFC components, Bluetooth® components (e.g., Bluetooth® Low Energy), Wi-Fi® components, and other communication components.

Instructions 1450 may comprise software, a program, an application, an applet, an app, or other executable code for causing at least any of the processors 1410 to perform any one or more of the methodologies discussed herein. The instructions 1450 may reside, completely or partially, within at least one of the processors 1410 (e.g., within the processor's cache memory), the memory/storage devices 1420, or any suitable combination thereof. Furthermore, any portion of the instructions 1450 may be transferred to the hardware resources 1400 from any combination of the peripheral devices 1404 or the databases 1406. Accordingly, the memory of processors 1410, the memory/storage devices 1420, the peripheral devices 1404, and the databases 1406 are examples of computer-readable and machine-readable media.

In embodiments, one or more devices, components, or portions or implementations thereof, of one or more of FIGS. 8, 9, 10, 13, and/or 14 or some other figure herein, may be to: create a network slice to enable a group based service (GBS); store configuration information that includes one or more of an application-ID, a wireless local area network (WLAN) service type, a temporary group based ID, synchronization information, or a virtual cell ID; and send the configuration information to one or more access stratum network entities.

In embodiments, one or more devices, components, or portions or implementations thereof, of one or more of FIGS. 8, 9, 10, 13, and/or 14 or some other figure herein, may be to: identify one or more configuration parameters in a signal from a non-3GPP interworking function (N3IWF); and communicate with a user equipment (UE) based at least in part on the configuration parameters, wherein the configuration parameters include one or more of an application-ID, a wireless local area network (WLAN) service type, a temporary group based ID, synchronization information, or a virtual cell ID.

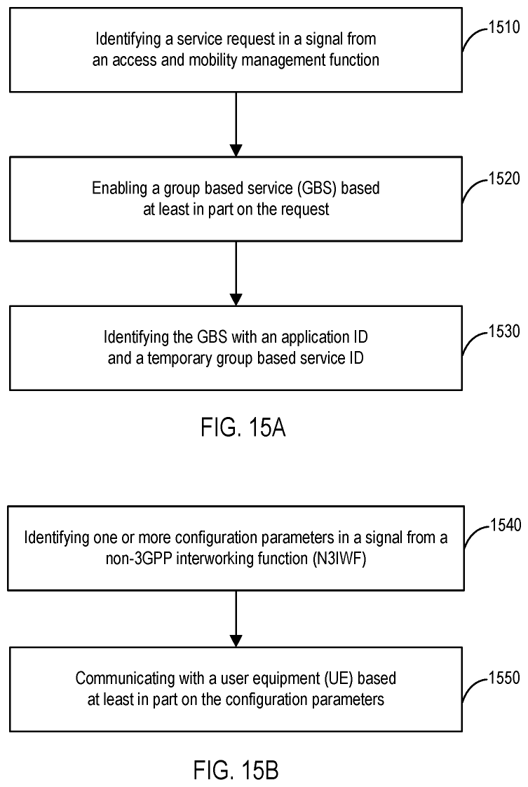

In some embodiments, the electronic device(s), network(s), system(s), chip(s) or component(s), or portions or implementations thereof, of FIG. 8, 9, 10, 13, 14, or some other figure herein may be configured to perform one or more processes, techniques, or methods as described herein, or portions thereof. One such process is depicted in FIG. 15A. For example, the process may include identifying 1510 or causing to identify a service request in a signal from an access and mobility management function (AMF); enabling 1520 or causing to enable a group based service (GBS) based at least in part on the service request; and identifying 1530 or causing to identify the GBS with an application ID and a temporary group based service ID (TGSID).

In some embodiments, the electronic device(s), network(s), system(s), chip(s) or component(s), or portions or implementations thereof, of FIG. 8, 9, 10, 13, 14, or some other figure herein may be configured to perform one or more processes, techniques, or methods as described herein, or portions thereof. One such process is depicted in FIG. 15B. For example, the process may include identifying 1540 or causing to identify one or more configuration parameters in a signal from a non-3GPP interworking function (N3IWF); and communicating 1550 or causing to communicate with a user equipment (UE) based at least in part on the configuration parameters, wherein the configuration parameters include one or more of an application-ID, a wireless local area network (WLAN) service type, a temporary group based ID, synchronization information, or a virtual cell ID.

In embodiments, the components of FIGS. 8, 9, 10, 13, and particularly the hardware resources of FIG. 14, may be to: identify a received message related to a group-based service from a first network entity; and transmit, based, at least in part, on the received message, a response message related to the group-based service to a second network entity.

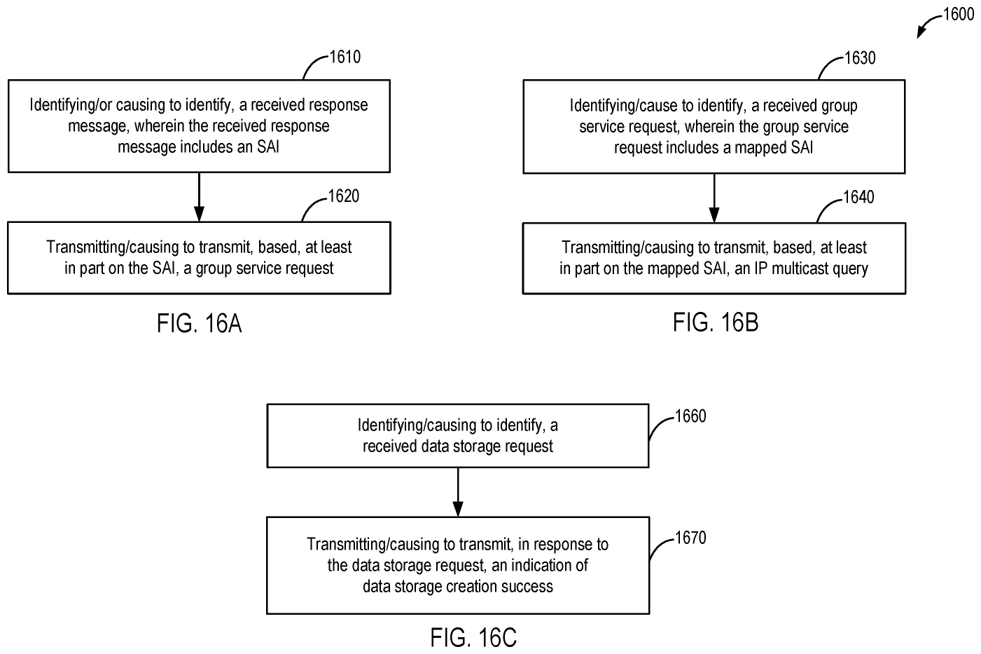

In some embodiments, the elements of FIG. 8, 9, 10, 13, or 14 may be configured to perform one or more processes, techniques, or methods as described herein, or portions thereof. One such process is depicted in FIG. 16A. For example, the process may include a method of controlling a groupcast session, the method comprising: identifying 1610, or causing to identify, a received response message, wherein the received response message includes a service area identification (SAD; and transmitting 1620, or causing to transmit, based, at least in part on the SAI, a group service request.

In some embodiments, the elements of FIG. 8, 9, 10, 13, or 14 may be configured to perform one or more processes, techniques, or methods as described herein, or portions thereof. One such process is depicted in FIG. 16B. For example, the process may include a method of establishing a groupcast session, the method comprising: identifying 1630, or causing to identify, a received group service request, wherein the group service request includes a mapped service area ID (SAD; and transmitting, or causing to transmit, based, at least in part on the mapped SAI, an IP multicast query.

In some embodiments, the elements of FIG. 8, 9, 10, 13, or 14 may be configured to perform one or more processes, techniques, or methods as described herein, or portions thereof. One such process is depicted in FIG. 16C. For example, the process may include a method of providing data storage for a groupcast session, the method comprising: identifying 1660, or causing to identify, a received data storage request; and transmitting 1670, or causing to transmit, in response to the data storage request, an indication of data storage creation success.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

Computer systems and the computers in a computer system may be connected via a network. Suitable networks for configuration and/or use as described herein include one or more local area networks, wide area networks, metropolitan area networks, and/or Internet or IP networks, such as the World Wide Web, a private Internet, a secure Internet, a value-added network, a virtual private network, an extranet, an intranet, or even stand-alone machines which communicate with other machines by physical transport of media. In particular, a suitable network may be formed from parts or entireties of two or more other networks, including networks using disparate hardware and network communication technologies.

One suitable network includes a server and one or more clients; other suitable networks may include other combinations of servers, clients, and/or peer-to-peer nodes, and a given computer system may function both as a client and as a server. Each network includes at least two computers or computer systems, such as the server and/or clients. A computer system may include a workstation, laptop computer, disconnectable mobile computer, server, mainframe, cluster, so-called “network computer” or “thin client,” tablet, smart phone, personal digital assistant or other hand-held computing device, “smart” consumer electronics device or appliance, medical device, or a combination thereof.

Suitable networks may include communications or networking software, such as the software available from Novell®, Microsoft®, and other vendors, and may operate using TCP/IP, SPX, IPX, and other protocols over twisted pair, coaxial, or optical fiber cables, telephone lines, radio waves, satellites, microwave relays, modulated AC power lines, physical media transfer, and/or other data transmission “wires” known to those of skill in the art. The network may encompass smaller networks and/or be connectable to other networks through a gateway or similar mechanism.

Various techniques, or certain aspects or portions thereof, may take the form of program code (i.e., instructions) embodied in tangible media, such as floppy diskettes, CD-ROMs, hard drives, magnetic or optical cards, solid-state memory devices, a nontransitory computer-readable storage medium, or any other machine-readable storage medium wherein, when the program code is loaded into and executed by a machine, such as a computer, the machine becomes an apparatus for practicing the various techniques. In the case of program code execution on programmable computers, the computing device may include a processor, a storage medium readable by the processor (including volatile and nonvolatile memory and/or storage elements), at least one input device, and at least one output device. The volatile and nonvolatile memory and/or storage elements may be a RAM, an EPROM, a flash drive, an optical drive, a magnetic hard drive, or other medium for storing electronic data. The eNB (or other base station) and UE (or other mobile station) may also include a transceiver component, a counter component, a processing component, and/or a clock component or timer component. One or more programs that may implement or utilize the various techniques described herein may use an application programming interface (API), reusable controls, and the like. Such programs may be implemented in a high-level procedural or an object-oriented programming language to communicate with a computer system. However, the program(s) may be implemented in assembly or machine language, if desired. In any case, the language may be a compiled or interpreted language, and combined with hardware implementations.

Each computer system includes one or more processors and/or memory; computer systems may also include various input devices and/or output devices. The processor may include a general purpose device, such as an Intel®, AMD®, or other “off-the-shelf” microprocessor. The processor may include a special purpose processing device, such as ASIC, SoC, SiP, FPGA, PAL, PLA, FPLA, PLD, or other customized or programmable device. The memory may include static RAM, dynamic RAM, flash memory, one or more flip-flops, ROM, CD-ROM, DVD, disk, tape, or magnetic, optical, or other computer storage medium. The input device(s) may include a keyboard, mouse, touch screen, light pen, tablet, microphone, sensor, or other hardware with accompanying firmware and/or software. The output device(s) may include a monitor or other display, printer, speech or text synthesizer, switch, signal line, or other hardware with accompanying firmware and/or software.

It should be understood that many of the functional units described in this specification may be implemented as one or more components, which is a term used to more particularly emphasize their implementation independence. For example, a component may be implemented as a hardware circuit comprising custom very large scale integration (VLSI) circuits or gate arrays, or off-the-shelf semiconductors such as logic chips, transistors, or other discrete components. A component may also be implemented in programmable hardware devices such as field programmable gate arrays, programmable array logic, programmable logic devices, or the like.

Components may also be implemented in software for execution by various types of processors. An identified component of executable code may, for instance, comprise one or more physical or logical blocks of computer instructions, which may, for instance, be organized as an object, a procedure, or a function. Nevertheless, the executables of an identified component need not be physically located together, but may comprise disparate instructions stored in different locations that, when joined logically together, comprise the component and achieve the stated purpose for the component.

Indeed, a component of executable code may be a single instruction, or many instructions, and may even be distributed over several different code segments, among different programs, and across several memory devices. Similarly, operational data may be identified and illustrated herein within components, and may be embodied in any suitable form and organized within any suitable type of data structure. The operational data may be collected as a single data set, or may be distributed over different locations including over different storage devices, and may exist, at least partially, merely as electronic signals on a system or network. The components may be passive or active, including agents operable to perform desired functions.

Several aspects of the embodiments described will be illustrated as software modules or components. As used herein, a software module or component may include any type of computer instruction or computer-executable code located within a memory device. A software module may, for instance, include one or more physical or logical blocks of computer instructions, which may be organized as a routine, program, object, component, data structure, etc., that perform one or more tasks or implement particular data types. It is appreciated that a software module may be implemented in hardware and/or firmware instead of or in addition to software. One or more of the functional modules described herein may be separated into sub-modules and/or combined into a single or smaller number of modules.

In certain embodiments, a particular software module may include disparate instructions stored in different locations of a memory device, different memory devices, or different computers, which together implement the described functionality of the module. Indeed, a module may include a single instruction or many instructions, and may be distributed over several different code segments, among different programs, and across several memory devices. Some embodiments may be practiced in a distributed computing environment where tasks are performed by a remote processing device linked through a communications network. In a distributed computing environment, software modules may be located in local and/or remote memory storage devices. In addition, data being tied or rendered together in a database record may be resident in the same memory device, or across several memory devices, and may be linked together in fields of a record in a database across a network.

Reference throughout this specification to “an example” means that a particular feature, structure, or characteristic described in connection with the example is included in at least one embodiment. Thus, appearances of the phrase “in an example” in various places throughout this specification are not necessarily all referring to the same embodiment.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on its presentation in a common group without indications to the contrary. In addition, various embodiments and examples may be referred to herein along with alternatives for the various components thereof. It is understood that such embodiments, examples, and alternatives are not to be construed as de facto equivalents of one another, but are to be considered as separate and autonomous representations.

Furthermore, the described features, structures, or characteristics may be combined in any suitable manner in one or more embodiments. In the following description, numerous specific details are provided, such as examples of materials, frequencies, sizes, lengths, widths, shapes, etc., to provide a thorough understanding of the embodiments. One skilled in the relevant art will recognize, however, that the embodiments may be practiced without one or more of the specific details, or with other methods, components, materials, etc. In other instances, well-known structures, materials, or operations are not shown or described in detail to avoid obscuring aspects of embodiments.

It should be recognized that the systems described herein include descriptions of specific embodiments. These embodiments can be combined into single systems, partially combined into other systems, split into multiple systems or divided or combined in other ways. In addition, it is contemplated that parameters/attributes/aspects/etc. of one embodiment can be used in another embodiment. The parameters/attributes/aspects/etc. are merely described in one or more embodiments for clarity, and it is recognized that the parameters/attributes/aspects/etc. can be combined with or substituted for parameters/attributes/etc. of another embodiment unless specifically disclaimed herein.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

### D. Additional Examples

Example 1 is an apparatus for group based service (GBS) provisioning for pervasive connectivity in a mobile network, the apparatus comprising: a memory interface and a processor. The memory interface to send or receive, to or from a memory device, and an application identifier (ID) value, and a temporary group based service ID (TGSID) value. The processor to: process a service request from an access and mobility management function (AMF), wherein the service request comprises the application ID value and the TGSID value associated with a groupcast service; and in response to the service request, enable groupcast service at one or more associated access stratum network entities for forwarding groupcast internet protocol (IP) packets.

Example 2 is the apparatus of Example 1, wherein the apparatus is configured for a non-3GPP interworking function (N3IWF), and wherein the one or more associated access stratum network entities comprise wireless local area network (WLAN)-access points (APs).

Example 3 is the apparatus of Example 2, wherein the one or more associated access stratum network entities are determined based on groupcast service area information sent by the AMF, and the groupcast service area information comprises one or more virtual cell identifiers, service set ID (SSID) of the associated WLAN-AP, or geographical information.

Example 4 is the apparatus Example 2, wherein the processor is further configured to: determine that the N3IWF includes an IP multicast capability; and in response to the determination that the N3IWF includes the IP multicast capability, perform an IP multicast joining procedure with the AMF for the groupcast service.

Example 5 is the apparatus of any of Examples 3-4, wherein the N3IWF processes groupcast transmission information, received from the AMF, of a user plane function (UPF), in which the groupcast transmission information comprises a groupcast IP flows ID and a data gateway (DGW) address or port in the UPF for groupcast IP flows.

Example 6 is the apparatus of any of Examples 1-4, wherein the apparatus is configured to store, through the memory interface, a groupcast context comprising the TGSID value, a groupcast IP flow identifier value, a downlink data gateway address or port value of a groupcast IP flow, and one or more virtual cell identifiers that has activated the groupcast service.

Example 7 is the apparatus of any of Examples 1-4, wherein the processor is further configured to, based on an authorized service area indicated by a service area identifier, reconfigure one or more virtual cells among the one or more associated access stratum network entities for the TGSID.

Example 8 is the apparatus of any of Examples 1-4, wherein the processor is further configured to: update system information to be broadcast; and send the updated system information to the one or more associated access stratum network entities.

Example 9 is the apparatus of Example 1, wherein the processor is further configured to: create a network slice for the groupcast service; store at least one parameter to the memory device comprising: application-ID, wireless local area network (WLAN) service types, temporary group based ID for using groupcast transmission, virtual cell ID, updated system information to be broadcast for the groupcast service, synchronization information, time schedule of transmission, and allocated internet protocol version 4 (IPv4) address pool or IPv6 subnet prefix; and generate signaling messages to indicate the at least one parameter to the one or more associated access stratum network entities.

Example 10 is the apparatus of Example 9, wherein the synchronization information is obtained from a user plane function (UPF) in the user plane transmission or from the AMF in a control plane signaling message.

Example 11 is the apparatus of Example 10, wherein the processor is further configured to provide updated system information with at least one of the following parameters: the application-ID, the WLAN service types, a service set ID (SSID)/extended SSID (ESSID)/basic SSID (BSSID) of WLAN-AP(s), virtual cell ID(s), and TGSID.

Example 12 is the apparatus of Example 9, wherein the WLAN service types provide a transmission mode used for the groupcast service and include broadcast, groupcast, and unicast.

Example 13 is the apparatus of Example 1, wherein the processor is further configured to: determine to enable the groupcast service in a unicast transmission mode for forwarding the groupcast IP packets to a user equipment (UE) that generated the service request; generate a response to AMF for the UE, which is identified by a temporary UE ID allocated during a registration procedure, to use unicast transmission of the groupcast service; store a UE context for the unicast transmission mode and provide corresponding context data to the one or more associated access stratum network entities; and in response to the service request from the AMF unicast information of a user plane function (UPF), store a groupcast context associated with the application ID.

Example 14 is the apparatus of Example 13, wherein the stored UE context for the unicast transmission includes one or more of the application ID, a wireless local area network (WLAN) service type indicated as unicast, a virtual cell ID, system information broadcast for the groupcast service; and an allocated IPv4 address pool/IPv6 subnet prefix.

Example 15 is the apparatus of Example 13, wherein the groupcast context includes one or more of the application ID, a virtual cell ID, a service set ID (SSID) of one or more wireless local area network (WLAN)-access points (APs), IP flow IDs, a data gateway address/port in the UPF for IP flows identified by the IP flow IDs, and a temporary UE ID for using the groupcast based service

Example 16 is the apparatus of Example 13, wherein the processor is further configured to, based on the stored groupcast context, forward received groupcast data from the UPF to the one or more associated access stratum network entities that use the groupcast service via unicast transmission toward corresponding WLAN-registered UEs.

Example 17 is the apparatus of Example 13, wherein the processor is further configured to share the unicast transmission locally toward one or more different UEs that later request the unicast transmission of the TGSID vial WLAN APs by using the same routing profiles of the UPF subject to a specific TGSID.

Example 18 is a computer-readable storage medium having computer-readable instructions stored thereon, the computer-readable instructions to, when executed, instruct a processor of a first access and mobility management function (AMF) to: receive, from an interworking function of a network, a service request associated with a user equipment (UE), wherein the service request includes at least one of an application identifier (ID) for a groupcast service and location information corresponding to the UE; determine whether the location information corresponds to an authorized service area of the groupcast service and whether a temporary group based service ID (TGSID) is valid or activated; when the location information does not correspond to the authorized service area, or when the TGSID is invalid or inactivated, generate a message for the interworking function to redirect the service request to a second AMF that has provisioned the groupcast service; and when the location information corresponds to the authorized service area and the TGSID is valid or activated, generate a message for the interworking function to enable the groupcast service.

Example 19 is the computer-readable storage medium of Example 18, wherein the location information comprises at least one of a virtual cell ID, a service set ID (SSID) of an associated wireless local area network (WLAN) access point (AP), and geographic information.

Example 20 is the computer-readable storage medium of Example 19, wherein to determine whether the location information corresponds to the authorized service area, based on at least one of the virtual cell ID, the SSID of the WLAN-AP, and geographical information, the computer-readable instructions are further to instruct the processor to query the interworking function for the location of the WLAN AP.

Example 21 is the computer-readable storage medium of Example 19, wherein the virtual cell ID is a global unique ID comprising an interworking function ID and a temporary cell ID allocated by the interworking function, and wherein to determine whether the TGSID is valid or activated, the computer-readable instructions are further to instruct the processor to parse the virtual cell ID for information of a registered interworking function to determine whether the TGSID is valid or activated at the interworking function, or process a stored groupcast context at the first AMF.

Example 22 is the computer-readable storage medium of any of Examples 18-21, wherein the stored groupcast context includes one or more of the TGSID, the virtual cell ID, one or more service area IDs (SAIs) indicating authorized service areas, and a user plane function (UPF) of the groupcast.

Example 23 is the computer-readable storage medium of any of Examples 18-21, wherein the interworking function comprises a non-3GPP interworking function (N3IWF).

Example 24 is the computer-readable storage medium of any of Examples 18-21, wherein the message for the interworking function to enable the groupcast service includes groupcast information comprising the application ID, the TGSID, a user plane function (UPF) routing profile of the groupcast, groupcast service area information, and the virtual cell ID(s).

Example 25 is the computer-readable storage medium of Example 24, wherein the UPF routing profile includes an ID for groupcast IP flows and a data gateway (DGW) address/port for the groupcast IP flows, and wherein the first AMF receives the TGSID in the UPF routing profile from either a network exposure function (NEF) or a session management function (SMF).

Example 26 is an apparatus comprising: means for determining one or more configuration parameters for one or more access stratum network entities as a virtual cell identified by a virtual cell identifier (ID) that includes one or more of a unique service set ID (SSID)/extended SSID (ESSID) across a control plane network entity, a particular channel for service, or one or more security settings; and means for communicating at least some of the configuration parameters to the one or more access stratum network entities.

Example 27 is the apparatus of Example 26, wherein the one or more access stratum network entities include one or more wireless local area network access points (WLAN-APs).

Example 28 is the apparatus of Example 26, wherein the security settings include one or more of a security mode, one or more security algorithm, one or more shared keys, or one or more renewal intervals.

Example 29 is the apparatus of Example 26, further comprising means for managing one or more virtual cells for a group based service identified with an application ID and associate to a temporary group service based ID (TGSID).

Example 30 is the apparatus of Example 29, further comprising means for storing a mapping between the virtual cell ID, the TGSID, the application ID, the SSID/ESSID, and a basic service set ID (BSSID) of the one or more access stratum network entities.

Example 31 is the apparatus of any of Examples 26-30, further comprising means for providing updated system information with one or more of an application ID, a WLAN service type, a WLAN-AP identifier, a virtual cell ID, or a TGSID.

Example 32 is the apparatus of Example 28, wherein the means for determining one or more configuration parameters for one or more access stratum network entities as a virtual cell identified by a virtual cell ID and the means for communicating at least some of the configuration parameters are included in a non-3GPP interworking function (N3IWF) or a portion or implementation thereof.

It will be understood by those having skill in the art that many changes may be made to the details of the above-described embodiments without departing from the underlying principles of the invention. The scope of the present invention should, therefore, be determined only by the following claims.

1. An apparatus for group based service (GBS) provisioning for pervasive connectivity in a mobile network, the apparatus comprising:
a memory interface to send or receive, to or from a memory device,
an application identifier (ID) value, and
a temporary group based service ID (TGSID) value; and
a processor to:
process a service request from an access and mobility management function (AMF),
wherein the service request comprises the application ID value and the TGSID value associated with a groupcast service; and
in response to the service request, enable groupcast service at one or more associated access stratum network entities for forwarding groupcast internet protocol (IP) packets.

2. The apparatus of claim 1, wherein the apparatus is configured for a non-3GPP interworking function (N3IWF), and wherein the one or more associated access stratum network entities comprise wireless local area network (WLAN)-access points (APs).

3. The apparatus of claim 2, wherein the one or more associated access stratum network entities are determined based on groupcast service area information sent by the AMF, and the groupcast service area information comprises one or more virtual cell identifiers, service set ID (SSID) of the associated WLAN-AP, or geographical information.

4. The apparatus claim 2, wherein the processor is further configured to:
determine that the N3IWF includes an IP multicast capability; and
in response to the determination that the N3IWF includes the IP multicast capability, perform an IP multicast joining procedure with the AMF for the groupcast service.

5. The apparatus of claim 3, wherein the N3IWF processes groupcast transmission information, received from the AMF, of a user plane function (UPF), in which the groupcast transmission information comprises a groupcast IP flows ID and a data gateway (DGW) address or port in the UPF for groupcast IP flows.

6. The apparatus of claim 1, wherein the apparatus is configured to store, through the memory interface, a groupcast context comprising the TGSID value, a groupcast IP flow identifier value, a downlink data gateway address or port value of a groupcast IP flow, and one or more virtual cell identifiers that has activated the groupcast service.

7. The apparatus of claim 1, wherein the processor is further configured to, based on an authorized service area indicated by a service area identifier, reconfigure one or more virtual cells among the one or more associated access stratum network entities for the TGSID.

8. The apparatus of claim 1, wherein the processor is further configured to:
update system information to be broadcast; and
send the updated system information to the one or more associated access stratum network entities.

9. The apparatus of claim 1, wherein the processor is further configured to:
create a network slice for the groupcast service;
store at least one parameter to the memory device comprising: application-ID, wireless local area network (WLAN) service types, temporary group based ID for using groupcast transmission, virtual cell ID, updated system information to be broadcast for the groupcast service, synchronization information, time schedule of transmission, and allocated internet protocol version 4 (IPv4) address pool or IPv6 subnet prefix; and
generate signaling messages to indicate the at least one parameter to the one or more associated access stratum network entities.

10. The apparatus of claim 9, wherein the synchronization information is obtained from a user plane function (UPF) in the user plane transmission or from the AMF in a control plane signaling message.

11. The apparatus of claim 10, wherein the processor is further configured to provide updated system information with at least one of the following parameters: the application-ID, the WLAN service types, a service set ID (SSID)/extended SSID (ESSID)/basic SSID (BSSID) of WLAN-AP(s), virtual cell ID(s), and TGSID.

12. The apparatus of claim 9, wherein the WLAN service types provide a transmission mode used for the groupcast service and include broadcast, groupcast, and unicast.

13. The apparatus of claim 1, wherein the processor is further configured to:
determine to enable the groupcast service in a unicast transmission mode for forwarding the groupcast IP packets to a user equipment (UE) that generated the service request;
generate a response to AMF for the UE, which is identified by a temporary UE ID allocated during a registration procedure, to use unicast transmission of the groupcast service;
store a UE context for the unicast transmission mode and provide corresponding context data to the one or more associated access stratum network entities; and
in response to the service request from the AMF unicast information of a user plane function (UPF), store a groupcast context associated with the application ID.

14. The apparatus of claim 13, wherein the stored UE context for the unicast transmission includes one or more of the application ID, a wireless local area network (WLAN) service type indicated as unicast, a virtual cell ID, system information broadcast for the groupcast service; and an allocated IPv4 address pool/IPv6 subnet prefix.

15. The apparatus of claim 13, wherein the groupcast context includes one or more of the application ID, a virtual cell ID, a service set ID (SSID) of one or more wireless local area network (WLAN)-access points (APs), IP flow IDs, a data gateway address/port in the UPF for IP flows identified by the IP flow IDs, and a temporary UE ID for using the groupcast based service.

16. The apparatus of claim 13, wherein the processor is further configured to, based on the stored groupcast context, forward received groupcast data from the UPF to the one or more associated access stratum network entities that use the groupcast service via unicast transmission toward corresponding WLAN-registered UEs.

17. The apparatus of claim 13, wherein the processor is further configured to share the unicast transmission locally toward one or more different UEs that later request the unicast transmission of the TGSID vial WLAN APs by using the same routing profiles of the UPF subject to a specific TGSID.

18. A computer-readable storage medium having computer-readable instructions stored thereon, the computer-readable instructions to, when executed, instruct a processor of a first access and mobility management function (AMF) to:
receive, from an interworking function of a network, a service request associated with a user equipment (UE), wherein the service request includes at least one of an application identifier (ID) for a groupcast service and location information corresponding to the UE;
determine whether the location information corresponds to an authorized service area of the groupcast service and whether a temporary group based service ID (TGSID) is valid or activated;
when the location information does not correspond to the authorized service area, or when the TGSID is invalid or inactivated, generate a message for the interworking function to redirect the service request to a second AMF that has provisioned the groupcast service; and
when the location information corresponds to the authorized service area and the TGSID is valid or activated, generate a message for the interworking function to enable the groupcast service.

19. The computer-readable storage medium of claim 18, wherein the location information comprises at least one of a virtual cell ID, a service set ID (SSID) of an associated wireless local area network (WLAN) access point (AP), and geographic information.

20. The computer-readable storage medium of claim 19, wherein to determine whether the location information corresponds to the authorized service area, based on at least one of the virtual cell ID, the SSID of the WLAN-AP, and geographical information, the computer-readable instructions are further to instruct the processor to query the interworking function for the location of the WLAN AP.

21. The computer-readable storage medium of claim 19, wherein the virtual cell ID is a global unique ID comprising an interworking function ID and a temporary cell ID allocated by the interworking function, and
wherein to determine whether the TGSID is valid or activated, the computer-readable instructions are further to instruct the processor to parse the virtual cell ID for information of a registered interworking function to determine whether the TGSID is valid or activated at the interworking function, or process a stored groupcast context at the first AMF.

22. The computer-readable storage medium of claim 18, wherein the stored groupcast context includes one or more of the TGSID, the virtual cell ID, one or more service area IDs (SAIs) indicating authorized service areas, and a user plane function (UPF) of the groupcast.

23. The computer-readable storage medium of claim 18, wherein the interworking function comprises a non-3GPP interworking function (N3IWF).

24. The computer-readable storage medium of claim 18, wherein the message for the interworking function to enable the groupcast service includes groupcast information comprising the application ID, the TGSID, a user plane function (UPF) routing profile of the groupcast, groupcast service area information, and the virtual cell ID(s).

25. The computer-readable storage medium of claim 24, wherein the UPF routing profile includes an ID for groupcast IP flows and a data gateway (DGW) address/port for the groupcast IP flows, and wherein the first AMF receives the TGSID in the UPF routing profile from either a network exposure function (NEF) or a session management function (SMF).

26. An apparatus comprising:
means for determining one or more configuration parameters for one or more access stratum network entities as a virtual cell identified by a virtual cell identifier (ID) that includes one or more of a unique service set ID (SSID)/extended SSID (ESSID) across a control plane network entity, a particular channel for service, or one or more security settings; and
means for communicating at least some of the configuration parameters to the one or more access stratum network entities.

27. The apparatus of claim 26, wherein the one or more access stratum network entities include one or more wireless local area network access points (WLAN-APs).

28. The apparatus of claim 26, wherein the security settings include one or more of a security mode, one or more security algorithm, one or more shared keys, or one or more renewal intervals.

29. The apparatus of claim 26, further comprising means for managing one or more virtual cells for a group based service identified with an application ID and associate to a temporary group service based ID (TGSID).

30. The apparatus of claim 29, further comprising means for storing a mapping between the virtual cell ID, the TGSID, the application ID, the SSID/ESSID, and a basic service set ID (BSSID) of the one or more access stratum network entities.

31. The apparatus of claim 26, further comprising means for providing updated system information with one or more of an application ID, a WLAN service type, a WLAN-AP identifier, a virtual cell ID, or a TGSID.

32. The apparatus of claim 28, wherein the means for determining one or more configuration parameters for one or more access stratum network entities as a virtual cell identified by a virtual cell ID and the means for communicating at least some of the configuration parameters are included in a non-3GPP interworking function (N3IWF) or a portion or implementation thereof.
